(19) United States
(12) Patent Application Publication
(10) Pub. No.: US 2011/0080503 A1
(43) Pub. Date: Apr. 7, 2011

(54) IMAGE SENSING APPARATUS

(75) Inventors: Seiji OKADA, Hirakata City (JP); You TOSHIMITSU, Koga City (JP); Akihiro MAENAKA, Kadoma City (JP)

(73) Assignee: SANYO ELECTRIC CO., LTD., Osaka (JP)

(21) Appl. No.: 12/896,516

(22) Filed: Oct. 1, 2010

(30) Foreign Application Priority Data
Oct. 2, 2009 (JP) 2009-230661
Sep. 1, 2010 (JP) 2010-195254

(51) Int. Cl. H04N 9/68; H04N 5/335

(52) U.S. Cl. 348/234; 348/294; 348/E09.053; 348/E05.091

(57) ABSTRACT

An image sensing apparatus includes an image sensor constituted of a light receiving pixel group which performs photoelectric conversion of an optical image of a subject, and a read control unit which performs switching between skip reading for thinning a part of the light receiving pixel group while reading an output signal of the light receiving pixel group, and addition reading for adding output signals of a plurality of light receiving pixels included in the light receiving pixel group while reading the same, for taking an image. The read control unit performs the switching between the skip reading and the addition reading while one moving image is being taken.

### CROSS-REFERENCE TO RELATED APPLICATIONS

This nonprovisional application claims priority under 35 U.S.C. §119(a) on Patent Application No. 2009-230661 filed in Japan on Oct. 2, 2009 and on Patent Application No. 2010-195254 filed in Japan on Sep. 1, 2010, the entire contents of which are hereby incorporated by reference.

### BACKGROUND OF THE INVENTION

1. Field of the Invention

The present invention relates to an image sensing apparatus such as a digital video camera.

2. Description of Related Art

As to a digital camera having an image sensor (such as a CCD) consisting of many light receiving pixels, when reading an image signal for a moving image from an image sensor, it is difficult to read the image signal from all the light receiving pixels at a frame rate suitable for the moving image (e.g., at 60 frames/sec) (except for the case where an expensive image sensor or a special image sensor capable of multi-channel reading can be used).

Therefore, there is usually adopted a method in which the number of pixels from which the signals are read is reduced by using an addition reading method of adding a plurality of light receiving pixel signals for reading, or a skip reading method of thinning some light receiving pixel signals for reading, so that high frame rate in obtaining the moving image is realized. In addition, a region reading method may be used in which only a light receiving pixel signal of a limited region (e.g., middle region) on the image sensor.

Among them, the addition reading method is often used because of its advantage that a signal-to-noise ratio (hereinafter referred to as an SN ratio) can be set to a relatively high value. However, as a matter of course, if the addition reading method is used, the resolution becomes lower than the case where all the light receiving pixels are read independently. Therefore, in recent years, as a method for improving the resolution, there is proposed to use a high-resolution technology such as a super-resolution technology in a process of generating a moving image. The super-resolution technology removes a folding noise (aliasing) that is generated by sampling in the image sensor, so that the resolution is improved.

The skip reading method is more advantageous than the addition reading method in view of application of the super-resolution technology. Compared with the image data obtained by the addition reading method, the image data obtained by the skip reading method contains more folding noise but can have more effect in improving the resolution by the super-resolution technology. However, on the other hand, the SN ratio becomes lower in using the skip reading method than the addition reading method. In particular, in the low illuminance, deterioration of the SN ratio may be too conspicuous. It is needless to say that a balance between the resolution and the SN ratio is important.

In addition, also in the case where image processing for improving the resolution and image processing for reducing noise are both used for trying to generate the moving image, a balance between the resolution and the SN ratio is important as a matter of course.

Note that there is also proposed a method of reading a thinning signal according to the skip reading method and an addition signal according to the addition reading method simultaneously, and using the two types of signals for generating a wide dynamic range image or a super-resolution image. However, this method requires to read twice larger amount of signals than usual from the image sensor. Therefore, this method is difficult to realize a high frame rate and is not suitable for generating a moving image. In addition, in order to read from the image sensor twice larger amount of signals than usual at high speed, it is necessary to increase output pins for reading signals. This causes increases in size and cost of the image sensor, so it is not practical.

### SUMMARY OF THE INVENTION

An image sensing apparatus for taking an image according to the present invention includes an image sensor constituted of a light receiving pixel group which performs photoelectric conversion of an optical image of a subject, and a read control unit which performs switching between skip reading for thinning a part of the light receiving pixel group while reading an output signal of the light receiving pixel group, and addition reading for adding output signals of a plurality of light receiving pixels included in the light receiving pixel group while reading the same. The read control unit performs the switching between the skip reading and the addition reading while one moving image is being taken.

Another image sensing apparatus according to the present invention includes an image processing unit which generates an output image from a taken image obtained from the image sensor by using first image processing for improving resolution of the taken image and second image processing for reducing noise of the taken image. The image processing unit generates the output image, so that the first image processing contributes to the output image more than the second image processing does when imaging sensitivity is relatively low and that the second image processing contributes to the output image more than the first image processing does when the sensitivity is relatively high. Alternatively, the image processing unit generates the output image, so that the first image processing contributes to the output image more than the second image processing does when brightness of a subject is relatively high, and that the second image processing contributes to the output image more than the first image processing does when the brightness is relatively low.

Meanings and effects of the present invention will be further apparent from the following description of an embodiment. However, the embodiment described below is merely an example of the present invention, and meanings of the present invention and terms of elements thereof are not limited to those described in the description of the following embodiment.

### BRIEF DESCRIPTION OF THE DRAWINGS

FIG. 1 is an entire block diagram of an image sensing apparatus according to an embodiment of the present invention.

FIG. 2 is an inner structure diagram of an imaging unit illustrated in FIG. 1.

FIG. 3A is a diagram illustrating a light receiving pixel arrangement in an effective pixel region of an image sensor according to the embodiment of the present invention, and FIG. 3B is a diagram illustrating the effective pixel region.

FIG. 4 is a diagram illustrating a color filter arrangement of the image sensor according to the embodiment of the present invention.

FIG. 5 is a diagram illustrating a manner in which a pixel signal of an original image is generated by all-pixel reading.

FIG. 6 is a diagram illustrating a manner in which a pixel signal of an original image is generated by addition reading.

FIG. 7 is a diagram illustrating a manner in which a pixel signal of an original image is generated by skip reading.

FIG. 8 is a block diagram of a part having a function of generating an output image from an input image, which is included in the image sensing apparatus illustrated in FIG. 1.

FIG. 9 is a diagram illustrating a relationship between time sequence and input image sequence.

FIG. 10 is a diagram illustrating a manner in which one image with improved resolution is generated from three input images.

FIG. 11A is a diagram illustrating a relationship between a signal amplification factor (G_{TOTAL}) and a drive system of the image sensor, and FIG. 11B is a diagram illustrating a relationship between the signal amplification factor and a weight coefficient (k_{W}), according to Example 1 of the present invention.

FIG. 12A is a diagram illustrating a relationship between a brightness control value (B_{CONT}) and a drive system of the image sensor, and FIG. 12B is a diagram illustrating a relationship between the brightness control value and the weight coefficient (k_{W}), according to Example 2 of the present invention.

FIG. 13 is a diagram illustrating a relationship between a signal amplification factor (G_{TOTAL}) and the drive system of the image sensor according to Example 3 of the present invention.

FIG. 14 is a diagram illustrating a manner in which the drive system of the image sensor changes along with a change of the signal amplification factor (G_{TOTAL}) according to Example 3 of the present invention.

FIG. 15 is a diagram for describing an image combining method according to Example 4 of the present invention.

FIG. 16 is a diagram illustrating an input image sequence in which an invalid frame exists, according to Example 6 of the present invention.

FIG. 17 is a diagram illustrating a manner in which an image sequence with improved resolution is generated when an invalid frame is generated, according to Example 6 of the present invention.

FIG. 18 is a diagram illustrating a manner in which an image corresponding to invalid frame is generated by interpolation when an invalid frame is generated, according to Example 6 of the present invention.

FIG. 19 is a first variation block diagram of a part having a function of generating an output image from an input image, according to Example 6 of the present invention.

FIG. 20 is a second variation block diagram of a part having a function of generating an output image from an input image, according to Example 7 of the present invention.

FIG. 21 is a diagram illustrating a manner in which a whole image region of the input image is classified into an edge region and a flat region, according to Example 7 of the present invention.

FIGS. 22A to 22D are diagrams illustrating first to fourth thinning patterns that are used in Example 8 of the present invention.

FIGS. 23A and 23B are diagrams illustrating first and second adding patterns that are used in Example 8 of the present invention.

FIGS. 24A and 24B are diagrams illustrating third and fourth adding patterns that are used in Example 8 of the present invention.

FIG. 25 is a diagram illustrating an input image sequence according to Example 10 of the present invention.

FIG. 26 is a diagram illustrating a manner in which a still image is generated from a plurality of input images, according to Example 10 of the present invention.

### DETAILED DESCRIPTION OF THE PREFERRED EMBODIMENTS

Hereinafter, an embodiment of the present invention will be described with reference to the attached, drawings. In each diagram to be referred to, the same part is denoted by the same numeral or symbol, so that overlapping description of the overlapped part is omitted as a general rule.

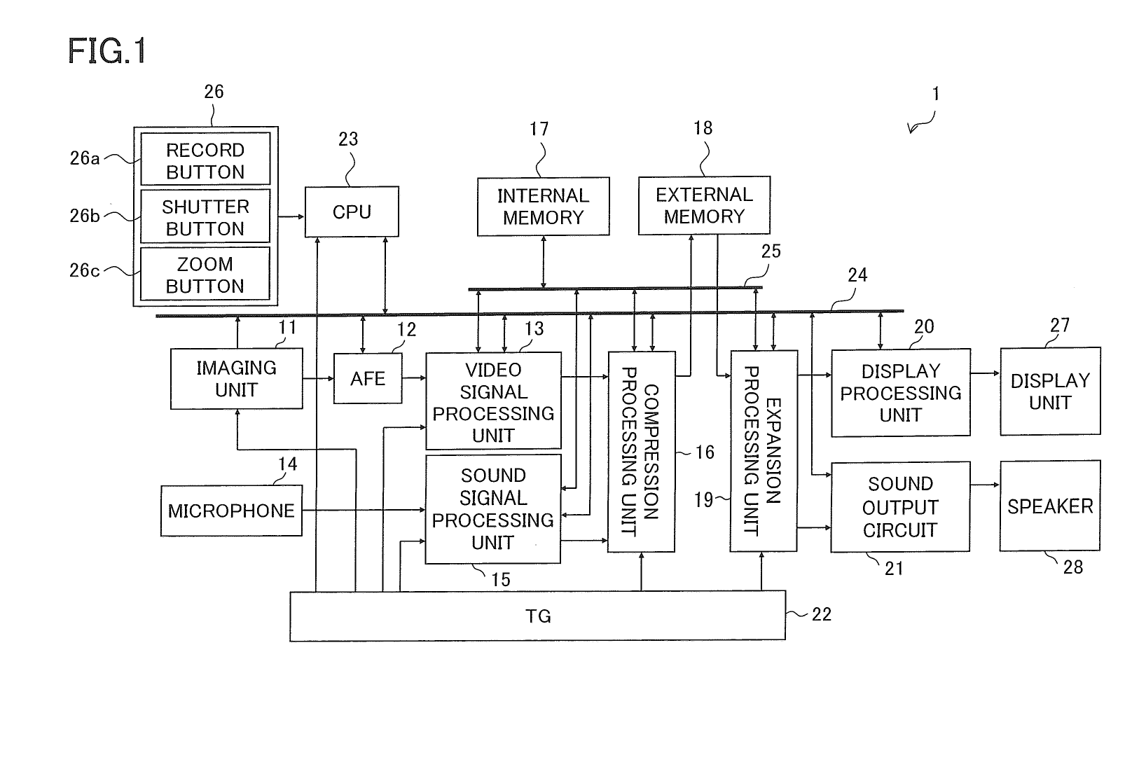

FIG. 1 is an entire block diagram of an image sensing apparatus 1 according to an embodiment of the present invention. The image sensing apparatus 1 includes individual parts denoted by numerals 11 to 28. The image sensing apparatus 1 is a digital video camera, which can take moving images and still images, and can take a still image while taking a moving image simultaneously. The individual parts of the image sensing apparatus 1 transmit and receive signals (data) via a bus 24 or 25 between the parts. Note that it is possible to interpret that a display unit 27 and/or a speaker 28 are disposed in an external device (not shown) of the image sensing apparatus 1.

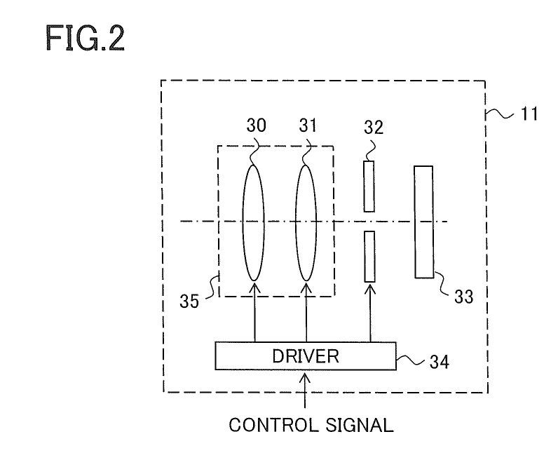

An imaging unit 11 takes subject images by using an image sensor. FIG. 2 is an inner structure diagram of the imaging unit 11. The imaging unit 11 includes an optical system 35, an aperture stop 32, an image sensor 33 constituted of a charge coupled device (CCD) or a complementary metal oxide semiconductor (CMOS) image sensor or the like, and a driver 34 which controls to drive the optical system 35 and the aperture stop 32. The optical system 35 is constituted of a plurality of lenses including a zoom lens 30 for adjusting an angle of view of the imaging unit 11 and a focus lens 31 for focusing. The zoom lens 30 and the focus lens 31 can move in the optical axis direction. Positions of the zoom lens 30 and the focus lens 31 in the optical system 35 and an opening degree of the aperture stop 32 are controlled on the basis of a control signal from a CPU 23, so that a focal length (angle of view) and a focal position of the imaging unit 11 and an incident light amount to the image sensor 33 are controlled.

The image sensor 33 is constituted of a plurality of light receiving pixels arranged in the horizontal and the vertical directions. The light receiving pixels of the image sensor 33 performs photoelectric conversion of an optical image of subject that enters via the optical system 35 and the aperture stop 32. The electric signal obtained by the photoelectric conversion is supplied to an analog front end (AFE 12).

The AFE 12 amplifies an analog signal output from the image sensor 33 (individual light receiving pixels) and converts the amplified analog signal into a digital signal, which is output to a video signal processing unit 13. An amplification factor of the signal amplification in the AFE 12 is controlled by a central processing unit (CPU) 23. The video signal processing unit 13 performs necessary image processing on the image expressed by the output signal of the AFE 12 so as to generate a video signal of the image after the image processing. A microphone 14 converts ambient sound of the image sensing apparatus 1 into an analog sound signal, and a sound signal processing unit 15 converts the analog sound signal into a digital sound signal.

A compression processing unit 16 compresses the video signal from the video signal processing unit 13 and the sound signal from the sound signal processing unit 15 by using a predetermined compression method. An internal memory 17, which is constituted of a dynamic random access memory (DRAM) or the like, stores various data temporarily. An external memory 18 as a recording medium, which is a nonvolatile memory such as a semiconductor memory or a magnetic disk, records the video signal and the sound signal after the compression by the compression processing unit 16.

An expansion processing unit 19 expands the compressed video signal and sound signal read from the external memory 18. The video signal after the expansion by the expansion processing unit 19 or the video signal from the video signal processing unit 13 is sent to the display unit 27 constituted of a liquid crystal display or the like via the display processing unit 20, and is displayed as an image. In addition, the sound signal after the expansion by the expansion processing unit 19 is sent to the speaker 28 via a sound output circuit 21, and is output as sound.

A timing generator (TG) 22 generates a timing control signal for controlling timings of operations in the entire image sensing apparatus 1, and supplies the generated timing control signal to the individual units in the image sensing apparatus 1. The timing control signal includes a vertical synchronizing signal Vsync and a horizontal synchronizing signal Hsync. The TG 22 further generates a driving pulse for the image sensor 33 under control of CPU 23 and supplies the same to the image sensor 33. The CPU 23 integrally controls actions of the individual parts in the image sensing apparatus 1. An operation part 26 includes a record button 26a for instructing start and end of taking a moving image and recording the same, a shutter button 26b for instructing to take and record a still image, a zoom button 26c for specifying a zoom magnification and the like, and receives various operations by a user. The contents of the operation to the operation part 26 are transmitted to the CPU 23.

Action modes of the image sensing apparatus 1 include an image taking mode in which moving images and still images can be taken, and a reproducing mode in which moving images and still images stored in the external memory 18 are reproduced and displayed by the display unit 27. In accordance with an operation to the operation part 26, a transition between the modes is performed.

In the image taking mode, images are taken sequentially at a specific frame period, so that a taken image sequence is obtained from the image sensor 33. As known well, a reciprocal number of the frame period is called a frame rate. The image sequence such as the taken image sequence means a set of images arranged in time sequence. In addition, data expressing the image is referred to as an image data. The image data is also a type of the video signal. The image data of one frame period expresses one image. The video signal processing unit 13 performs various image processings on the image expressed by the output signal of the AFE 12, and the image expressed by the output signal itself of the AFE 12 before the image processing is performed is referred to as an original image. Therefore, the output signal of the AFE 12 of one frame period expresses one original image.

[Light Receiving Pixel Arrangement of Image Sensor]

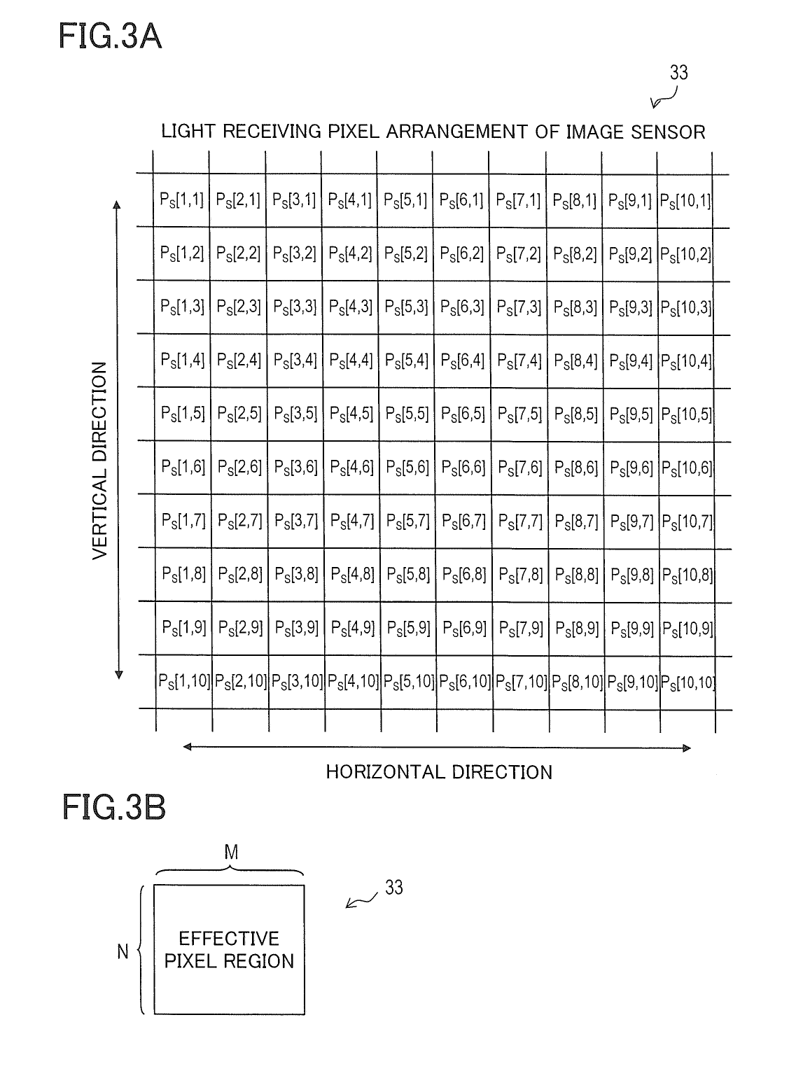

FIG. 3A illustrates a light receiving pixel arrangement in an effective pixel region of the image sensor 33. The effective pixel region of the image sensor 33 has a rectangular shape, and one apex of the rectangle is regarded as an origin on the image sensor 33. It is supposed that the origin is positioned at the upper left corner of the effective pixel region of the image sensor 33. As illustrated in FIG. 3B, the light receiving pixels of the number corresponding to a product (M×N) of the number of effective pixels M in the horizontal direction and the number of effective pixels N in the vertical direction of the image sensor 33 are arranged in a two-dimensional manner, so that the effective pixel region of the image sensor 33 is formed. Each light receiving pixel in the effective pixel region of the image sensor 33 is expressed by P_{S}[x,y]. Here, x and y are integers and satisfy 1≦x≦M and 1≦y≦N. M and N are integers of two or larger, which have values, for example, within the range of a few hundreds to a few thousands. Viewing from the origin of the image sensor 33, as a light receiving pixel is positioned closer to the right side, the corresponding variable x has a larger value. Further, as a light receiving pixel is positioned closer to the lower side, the corresponding variable y has a larger value. In the image sensor 33, the up and down direction corresponds to the vertical direction, while the left and right direction corresponds to the horizontal direction.

FIG. 3A illustrates total 100 light receiving pixels P_{S}[x,y] satisfying an inequality “1≦x≦10” and an inequality “1≦y≦10”. Among the light receiving pixel group illustrated in FIG. 3A, an arrangement position of the light receiving pixel P_{S}[1,1] is closest to the origin of the image sensor 33, and the an arrangement position of the light receiving pixel P_{S}[10,10] is farthest from the origin of the image sensor 33.

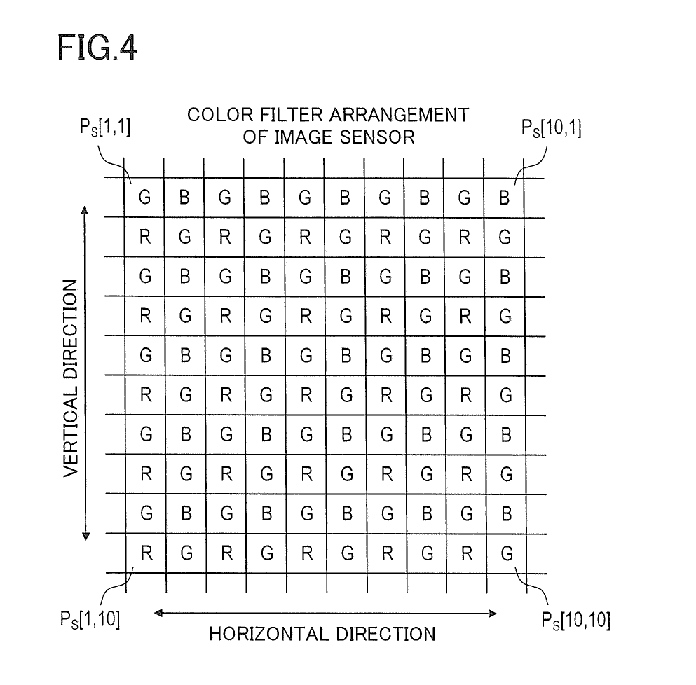

The image sensing apparatus 1 adopts a so-called single plate method in which only one image sensor is used. FIG. 4 illustrates an arrangement of color filters disposed on the front side of the light receiving pixels of the image sensor 33. The arrangement illustrated in FIG. 4 is usually called a Bayer arrangement. The color filters include a red filter that transmits only a red light component, a green filter that transmits only a green light component, and a blue filter that transmits only a blue light component. The red filter is disposed on the front side of the light receiving pixel P_{S}[2n_{A}−1,2n_{B}], the blue filter is disposed on the front side of the light receiving pixel P_{S}[2n_{A},2n_{B}−1], and the green filter is disposed on the front side of the light receiving pixel P_{S}[2n_{A}−1,2n_{B}−1] or P_{S}[2n_{A},2n_{B}]. Here, n_{A} and n_{B} are integers. Further, in FIG. 4 and in FIGS. 5 to 7 and 22A to 22D that will be referred to later, a part corresponding to the red filter is denoted by R, a part corresponding to the green filter is denoted by G, and a part corresponding to the blue filter is denoted by B.

The light receiving pixels with the red filter, the green filter and the blue filter disposed on the front side thereof are also referred to as a red light receiving pixel, a green light receiving pixel, and a blue light receiving pixel, respectively. Each light receiving pixel converts the light entering the same through the color filter into an electric signal by the photoelectric conversion. This electric signal represents a pixel signal of the light receiving pixel, and may be referred to as a “light receiving pixel signal” hereinafter. The red light receiving pixel, the green light receiving pixel, and the blue light receiving pixel respond only to a red component, a green component, and a blue component, respectively, of the incident light of the optical system.

[Reading Method of Light Receiving Pixel Signal]

As the method of reading the light receiving pixel signal from the image sensor 33, there are an all-pixel reading method in which the light receiving pixel signal is read out from all the light receiving pixel separately in the effective pixel region of the image sensor 33, an addition reading method in which a plurality of light receiving pixel signals are added up for reading, and a skip reading method in which some light receiving pixel signals are thinned out for reading.

(All-Pixel Reading Method)

The all-pixel reading method will be described. When the light receiving pixel signal is read out from the image sensor 33 by the all-pixel reading method, the light receiving pixel signals from all the light receiving pixels in the effective pixel region of the image sensor 33 are separately supplied to the video signal processing unit 13 via the AFE 12.

Therefore, when the all-pixel reading method is used, as illustrated in FIG. 5, 4×4 light receiving pixel signals of 4×4 light receiving pixels are amplified and digitized by the AFE 12 to be 4×4 pixel signals of the 4×4 pixels on the original image. Note that the 4×4 light receiving pixels means total 16 light receiving pixels that are arranged like a matrix, namely, four light receiving pixels in the horizontal direction and four light receiving pixels in the vertical direction. The same is true for the 4×4 pixels.

When the all-pixel reading method is used, as illustrated in FIG. 5, the light receiving pixel signal of the light receiving pixel P_{S}[x,y] is amplified and digitized by the AFE 12 to be a pixel signal of the pixel at the pixel position [x,y] on the original image. In an arbitrary noted image including an original image, a position on the noted image where the pixel is disposed is referred to as the pixel position and represented by symbol [x,y]. For convenience sake, it is supposed that the origin on the noted image is positioned at the upper left corner of the noted image similarly to the image sensor 33. It is supposed that when viewed from the origin on the noted image, as the pixel on the noted image is positioned closer to the right side, a value of the corresponding variable x becomes larger. As the pixel on the noted image is positioned closer to the lower side, a value of the corresponding variable y becomes larger. In the noted image, the up and down direction corresponds to the vertical direction, while the left and right direction corresponds to the horizontal direction.

In the original image, a pixel signal of only one color component, which is one of the red component, the green component and the blue component, exists with respect to one pixel position. In an arbitrary noted image including the original image, the pixel signals indicating data of the red component, the green component and the blue component are referred to as an R signal, a G signal, and a B signal, respectively.

When the all-pixel reading method is used, a pixel signal of the pixel disposed on the pixel position [2n_{A}−1,2n_{B}] on the original image is an R signal, a pixel signal of the pixel disposed on the pixel position [2n_{A},2n_{B}−1] on the original image is a B signal, and a pixel signal of the pixel disposed on the pixel position [2n_{A}−1,2n_{B}−1] or [2n_{A},2n_{B}] on the original image is a G signal.

(Addition Reading Method)

The addition reading method will be described. When a light receiving pixel signal is read out from the image sensor 33 by the addition reading method, a plurality of light receiving pixel signals are added up, and the obtained addition signal is supplied to the video signal processing unit 13 from the image sensor 33 via the AFE 12, so that one addition signal forms a pixel signal of one pixel on the original image.

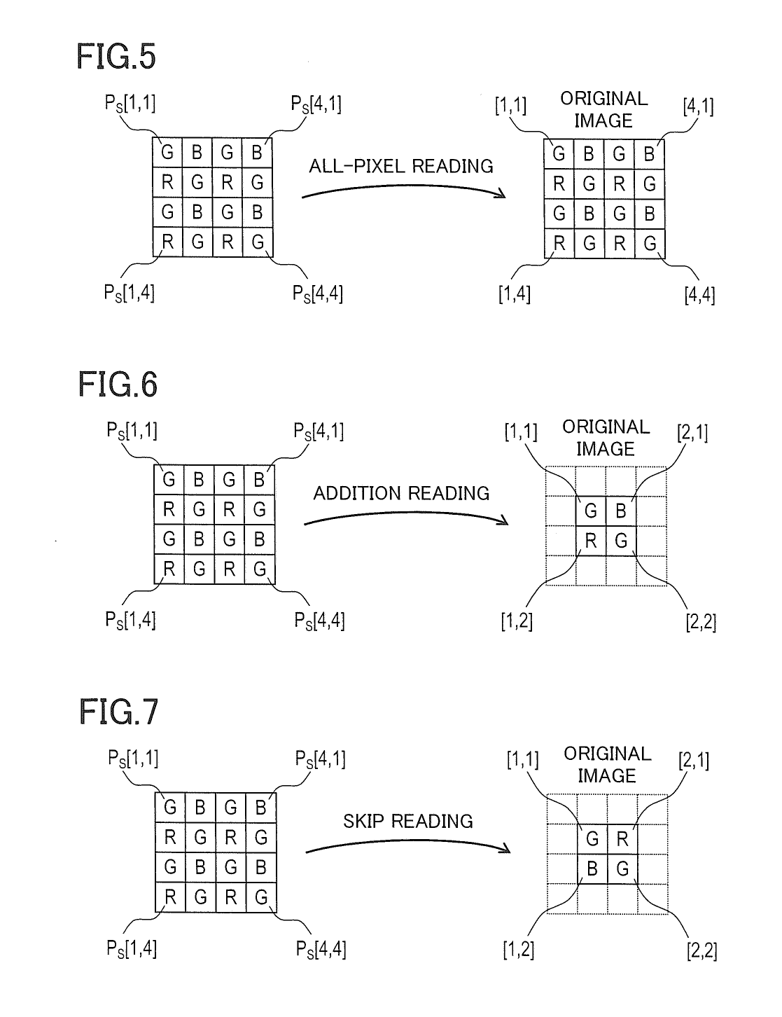

There are various methods as the adding method of the light receiving pixel signals. As one example, FIG. 6 illustrates a manner of obtaining the original image by using the addition reading method. In the example illustrated in FIG. 6, four light receiving pixels signals are added up for generating one addition signal. When this addition reading method is used, the effective pixel region of the image sensor 33 is regarded to be divided into a plurality of small light receiving pixel regions. Each of the small light receiving pixel regions is constituted of 4×4 light receiving pixels, and four addition signals are generated from one small light receiving pixel region. Each of the four addition signals generated for each small light receiving pixel region is read out as a pixel signal of the pixel on the original image.

For instance, when the small light receiving pixel region constituted of the light receiving pixels P_{S}[1,1] to P_{S}[4,4] is noted, the light receiving pixel signals of the light receiving pixels P_{S}[1,1], P_{S}[3,1], P_{S}[1,3], and P_{S}[3,3] are added up, and the obtained addition signal is amplified and digitized by the AFE 12 to be the pixel signal at the pixel position [1,1] (G signal) on the original image. The light receiving pixel signals of the light receiving pixels P_{S}[2,1], P_{S}[4,1], P_{S}[2,3], and P_{S}[4,3] are added up, and the obtained addition signal is amplified and digitized by the AFE 12 to be a pixel signal at the pixel position [2,1] (B signal) on the original image. The light receiving pixel signals of the light receiving pixels P_{S}[1,2], P_{S}[3,2], P_{S}[1,4], and P_{S}[3,4] are added up, and the obtained addition signal is amplified and digitized by the AFE 12 to be a pixel signal at the pixel position [1,2] (R signal) on the original image. The light receiving pixel signals of the light receiving pixels P_{S}[2,2], P_{S}[4,2], P_{S}[2,4], and P_{S}[4,4] are added up, and the obtained addition signal is amplified and digitized by the AFE 12 to be a pixel signal at the pixel position [2,2] (G signal) on the original image.

Such the reading by the addition reading method is performed with respect to each of the small light receiving pixel regions. Thus, the pixel signal of the pixel at the pixel position [2n_{A}−1,2n_{B}] on the original image becomes an R signal, the pixel signal of the pixel at the pixel position [2n_{A},2n_{B}−1] on the original image becomes the B signal, and the pixel signal of the pixel at the pixel position [2n_{A}−1,2n_{B}−1] or [2n_{A},2n_{B}] on the original image becomes the G signal.

(Skip Reading Method)

The skip reading method will be described. When the light receiving pixel signal is read out from the image sensor 33 by the skip reading method, some light receiving pixel signals are thinned out. In other words, only the light receiving pixel signals of some light receiving pixels among all the light receiving pixels in the effective pixel region of the image sensor 33 are supplied to the video signal processing unit 13 from the image sensor 33 via the AFE 12, and the pixel signal of one pixel on the original image is formed by one light receiving pixel signal supplied to the video signal processing unit 13.

There are various methods as the thinning method of the light receiving pixel signal. As one example, FIG. 7 illustrates a manner of obtaining the original image by using the skip reading method. In this example, the effective pixel region of the image sensor 33 is regarded to be divided into a plurality of small light receiving pixel regions. Each of the small light receiving pixel regions is constituted of 4×4 light receiving pixels. Only four light receiving pixels signals are read out from one small light receiving pixel region as pixel signals of the pixels on the original image.

For instance, when the small light receiving pixel region constituted of the light receiving pixels P_{S}[1,1] to P_{S}[4,4] is noted, the light receiving pixel signals of the light receiving pixel P_{S}[2,2], P_{S}[3,2], P_{S}[2,3], and P_{S}[3,3] are amplified and digitized by the AFE 12 to be the pixel signals at the pixel positions [1,1], [2,1], [1,2], and [2,2], respectively, on the original image. The pixel signals at the pixel positions [1,1], [2,1], [1,2], and [2,2] on the original image are G signal, R signal, B signal, and G signal, respectively.

Such the reading by the skip reading method is performed with respect to each small light receiving pixel region. Thus, the pixel signal of the pixel disposed at the pixel position [2n_{A}−1,2n_{B}] on the original image becomes the B signal. The pixel signal of the pixel disposed at the pixel position [2n_{A},2n_{B}−1] on the original image becomes the R signal. The pixel signal of the pixel disposed at the pixel position [2n_{A}−1,2n_{B}−1] or [2n_{A},2n_{B}] on the original image becomes the G signal.

Hereinafter, the signal readings by the all-pixel reading method, the addition reading method, and the skip reading method are referred to as all-pixel reading, addition reading, and skip reading, respectively. The all-pixel reading method, the addition reading method, and skip reading method are generically referred to as a drive system. In addition, in the following description, when being referred to an addition reading method or addition reading simply, it means the addition reading method or the addition reading described above with reference to FIG. 6, and when being referred to a skip reading method or skip reading simply, it means the skip reading method or the skip reading described above with reference to FIG. 7.

The original image obtained by the all-pixel reading and the original image obtained by the addition reading or skip reading have the same angle of view. In other words, supposing the image sensing apparatus 1 and subject are stationary during a period of taking both the original images, both the original images indicate the same subject image.

However, an image size of the original image obtained by the all-pixel reading is M×N, while an image size of the original image obtained by the addition reading or the skip reading is M/2×N/2. In other words, the number of pixels of the original image obtained by the all-pixel reading are M and N in the horizontal direction and in the vertical direction, respectively, while the number of pixels of the original image obtained by the addition reading or the skip reading are M/2 and N/2 in the horizontal direction and in the vertical direction.

If either reading method is used, the R signals are arranged like a mosaic on the original image. The same is true for the B and G signals. The video signal processing unit 13 illustrated in FIG. 1 can perform a color interpolation process called a demosaicing process on the original image so as to generate a color interpolation image from the original image. In the color interpolation image, all the R, G and B signals exist with respect to one pixel position. Otherwise, all the luminance signal Y and color difference signals U and V exist with respect to one pixel position.

When the image sensing apparatus 1 takes a still image responding to the pressing operation of the shutter button 26b, the original image can be generated by the all-pixel reading. Also in the case where a moving image is taken responding to the pressing operation of the record button 26a, it is possible to generate the original image sequence by the all-pixel reading. However, the image sensing apparatus 1 has a characteristic function of generating the original image sequence by switching to the addition reading or the skip reading when a moving image is taken. The following description is a description of the operation of the image sensing apparatus 1 in the case where the above-mentioned characteristic function is realized unless otherwise noted.

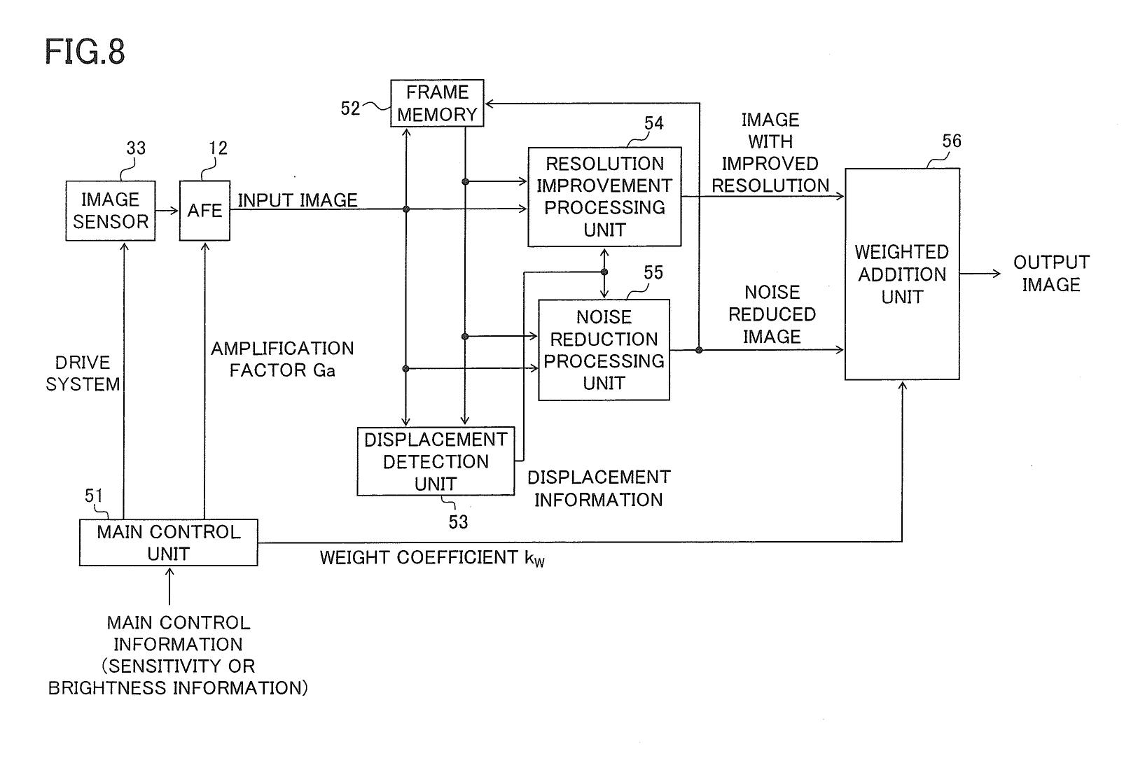

FIG. 8 illustrates a block diagram of a part which mainly performs the characteristic function. A main control unit 51 can be realized by the TG 22 and the CPU 23, or by the video signal processing unit 13, the TG 22, and the CPU 23. A frame memory 52 can be disposed in the internal memory 17. A displacement detection unit 53, a resolution improvement processing unit 54, a noise reduction processing unit 55, and a weighted addition unit 56 can be disposed in the video signal processing unit 13.

The main control unit 51 performs control of a drive system of the image sensor 33 and control of the amplification factor of the signal amplification in the AFE 12 on the basis of main control information (main control information will be described later). According to control by the main control unit 51, the signal is read out from the image sensor 33 by one of the addition reading method and the skip reading method. The AFE 12 amplifies the output signal of the image sensor 33 by the amplification factor Ga according to control of the main control unit 51 and converts the amplified signal into a digital signal. Note that the main control unit 51 also sets a weight coefficient k_{W} in accordance with the main control information, and the setting method will be described later.

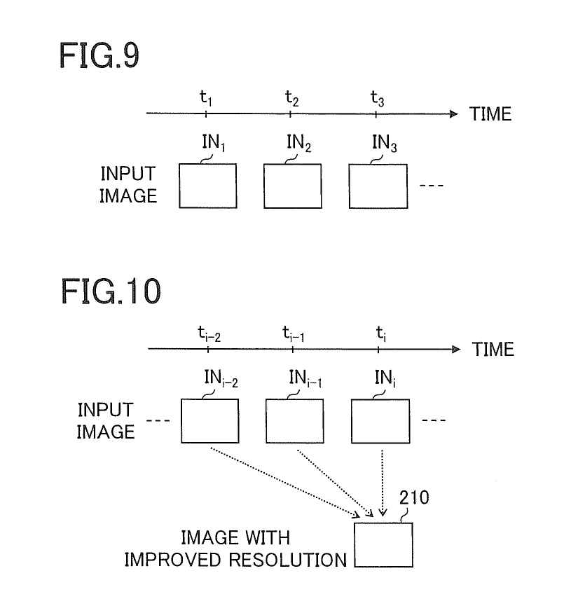

The frame memory 52 temporarily stores the necessary number of image data of the input image on the basis of the output signal of the AFE 12. Here, the input image means the above-mentioned original image or color interpolation image. The image data stored in the frame memory 52 is appropriately sent to the resolution improvement processing unit 54 and the noise reduction processing unit 55. It is supposed that the moving image obtained by imaging includes the input images IN₁, IN₂, IN₃, and so on as illustrated in FIG. 9. IN, indicates one input image obtained by imaging at time tᵢ (i is an integer). Time tᵢ₊₁ is after time tᵢ, and a time length between time tᵢ and time tᵢ₊₁ is the same as the frame period. Therefore, the input image INᵢ₊₁ is an input image that is obtained next to the input image INᵢ.

The displacement detection unit 53 calculates a displacement amount between the input images INᵢ and INᵢ₊₁ on the basis of the image data of the input images INᵢ and INᵢ₊₁, and generates displacement information indicating the displacement amount. The displacement amount is a two-dimensional amount including a horizontal component and a vertical component. However, the displacement amount calculated by the displacement detection unit 53 may be a geometric conversion parameter including image rotation, enlargement, reduction, or the like, too. Considering with respect to the input image INᵢ, the input image INᵢ₊₁ can be regarded as an image obtained by displacing the input image IN, by a displacement amount between the input images INᵢ and INᵢ₊₁. In order to derive the displacement amount, it is possible to use a displacement amount estimation algorithm utilizing a representative point matching method, a block matching method, a gradient method or the like. The displacement amount determined here has a resolution higher than the pixel interval of the input image, namely a so-called sub pixel resolution. In other words, the displacement amount is calculated by a minimum unit that is a distance shorter than the interval between two neighboring pixels in the input image. As a method of calculating the displacement amount having a sub pixel resolution, a known calculation method can be used. For instance, it is possible to use a method described in JP-A-11-345315 or a method described in Okutomi, “Digital Image Processing”, second edition, CG-ARTS Association, 2007, March, 1 (page 205).

The resolution improvement processing unit 54 combines a plurality of input images that are successive in a temporal manner on the basis of the displacement information, so as to reduce folding noise (aliasing) caused by sampling in the image sensor 33 and thus improve resolution of the input image. The image sensor 33 performs sampling of the analog image signal by using the light receiving pixel, and this sampling causes the folding noise, which is mixed into each input image. The resolution improvement processing unit 54 generates one image with improved resolution corresponding to an image with reduced folding noise from a plurality of input images that are successive in a temporal manner by the resolution improving process using the displacement information.

In the resolution improving process, a latest input image and one or a few previous frame input images are combined with reference to the latest input image. The number of input images that are used for generating one image with improved resolution may be any number of two or larger. For specific description, it is supposed that one image with improved resolution is generated from the three input image in principle. In this case, as illustrated in FIG. 10, in the resolution improving process, the input images to IN, are combined on the basis of the displacement amount between the input image INᵢ₋₂ and INᵢ and the displacement amount between the input image INᵢ₋₁ and INᵢ, so that an image with improved resolution 210 having a resolution higher than the input images INᵢ₋₂ to IN, is generated. The maximum spatial frequency expressed by the image with improved resolution 210 is larger than that of each of the input images INᵢ₋₂ to INᵢ. The image with improved resolution based on the input images INᵢ₋₂ to INᵢ is referred to as an image with improved resolution at time tᵢ. As a method of the above-mentioned resolution improving process, an arbitrary method including known methods can be used. Note that this type of resolution improving process is also referred to as a super-resolution process.

The noise reduction processing unit 55 combines a plurality of images including the input image on the basis of the displacement information so as to reduce noise contained in each input image. Here, the noise to be reduced is mainly noise that is generated at random in each input image (so-called random noise). The image processing for reducing noise performed by the noise reduction processing unit 55 is referred to as a noise reduction process, and the image obtained by the noise reduction process is referred to as a noise reduced image.

In the noise reduction process, the latest input image and one or a few previous frame input images (or noise reduced images) are combined with reference to the latest input image. As the noise reduction process, it is possible to use a cyclic noise reduction process which is also called a three-dimensional noise reduction process. In the cyclic noise reduction process, when the input image INᵢ is obtained as the latest input image, the noise reduced image based on the input image at time tᵢ₋₁ and input image before time (hereinafter referred to as a noise reduced image at time tᵢ₋₁) and the input image INᵢ are combined so that the noise reduced image at time tᵢ is generated. In this generation step, the displacement amount between the images to be combined is used. When the cyclic noise reduction process is used, the image data of the noise reduced image output from the noise reduction processing unit 55 is resupplied to the noise reduction processing unit 55 via the frame memory 52. The noise reduced image at time tᵢ corresponds to the input image at time tᵢ after the noise reduction.

As the noise reduction process in the noise reduction processing unit 55, it is possible to use an FIR noise reduction process. In the FIR noise reduction process, when the input image INᵢ is obtained as the latest input image, the input images INᵢ₋₂ to INᵢ are combined on the basis of a displacement amount between the input images INᵢ₋₂ and a displacement amount between the input images INᵢ₋₁ and INᵢ, for example, (i.e., the input images INᵢ₋₂ to INᵢ are aligned so that the position displacement between the input images INᵢ₋₂ to INᵢ is canceled, while the pixel signals corresponding to the input images INᵢ₋₂ to INᵢ are added up with weights), so that the noise reduced image at time tᵢ is generated. Note that when the FIR noise reduction process is used, it is not necessary to send the output data of the noise reduction processing unit 55 to the frame memory 52.

In each of the resolution improving process and the noise reduction process, image data of the latest input image is included in the latest image with improved resolution and the latest noise reduced image as it is, for preventing occurrence of a ghost image, with respect to an image region that is decided to have a motion. The image region that is decided to have a motion includes a moving object region. The moving object region means an image region where exists image data of a moving object that moves on the moving image formed from the input image sequence.

The weighted addition unit 56 generates an output image by combining the image with improved resolution and the noise reduced image in accordance with the weight coefficient k_{W} sent from the main control unit 51. The image with improved resolution at time tᵢ is combined with the noise reduced image at time tᵢ. The output image based on the image with improved resolution and the noise reduced image at time tᵢ is referred to as an output image at time tᵢ.

The pixel signal at the pixel position [x,y] on the image with improved resolution at time tᵢ, the pixel signal at the pixel position [x,y] on the noise reduced image at time tᵢ, and the pixel signal at the pixel position [x,y] on the output image at time tᵢ are represented by V_{A}[x,y], V_{A}[x,y], and V_{OUT}[x,y], respectively. Then, V_{OUT}[x,y] is determined by the following equation.

V_{OUT}[x,y]=k_{W}×V_{A}[x,y]+(1−k_{W})×V_{B}[x,y]

The image data of the output image sequence can be recorded in the external memory 18 as image data of the moving image obtained by the pressing operation of the record button 26a. However, it is also possible to record image data of the input image sequence, image data of the image sequence with improved resolution, and/or image data of the noise reduced image sequence in the external memory 18.

Hereinafter, details of the control operation and the like of the drive system on the basis of the main control information will be described in Examples 1 to 10. It is also possible to combine and perform a plurality of examples among Example 1 to 10, as long as no contradiction arises. It is also possible to apply the matter described in a certain example to another example, as long as no contradiction arises.

### Example 1

Example 1 will be described. The main control information supplied to the main control unit 51 illustrated in FIG. 8 in Example 1 is sensitivity information corresponding to imaging sensitivity (in other words, sensitivity information corresponding to sensitivity of the image sensing apparatus 1). A signal amplification factor G_{TOTAL} of the entire image sensing apparatus is defined by the sensitivity information (it is possible to regard that the sensitivity information is the signal amplification factor G_{TOTAL} itself). Viewing from a certain reference state, if the imaging sensitivity becomes k₁ times, the signal amplification factor G_{TOTAL} also becomes k₁ times. In addition, if the signal amplification factor G_{TOTAL} becomes k₁ times, the imaging sensitivity also becomes k₁ times (k₁ is an arbitrary positive number).

The signal amplification factor G_{TOTAL} of the entire image sensing apparatus means a product of an amplification factor when the pixel signal is amplified at the signal processing stage and an amplification factor Go which depends on the drive system of the image sensor 33. The former amplification factor is the amplification factor Ga of the signal in the AFE 12. The latter amplification factor Go is determined with reference to the skip reading method. In other words, the amplification factor Go when the skip reading is performed is one. Under a certain constant condition, if an input signal level of the AFE 12 when the addition reading is performed is k₂ times of that when the skip reading is performed, the amplification factor Go when the addition reading is performed is k₂ (k₂>1). When the addition reading corresponding to FIG. 6 is performed, the four light receiving pixels signals are added up. Therefore, the amplification factor Go when the addition reading is performed is four. In other words, it can be said that sensitivity of the input signal of the AFE 12 when the addition reading is performed is four times higher than that when the skip reading is performed. As a matter of course, the numerical value “four” of the amplification factor Go is merely an example of a specific numerical value supposed in this embodiment including Example 1. Depending on characteristic of the image sensor 33 or the adding method in the addition reading, this numerical value may be a value other than four.

As understood from the above description, the signal amplification factor G_{TOTAL} of the entire image sensing apparatus is expressed as follows.

G_{TOTAL}=Ga×Go

The signal amplification factor G_{TOTAL} is basically determined from an AE score on the basis of the image data of the input image. The AE score is calculated by an AE control unit (not shown) included in the CPU 23 or the video signal processing unit 13, for each input image. The AE score of the noted input image is an average luminance of the image in the AE evaluation region set in the noted input image. The AE evaluation region of the noted input image may be a whole image region of the noted input image or a part of the same. The AE control unit determines the signal amplification factor G_{TOTAL} on the basis of the AE score calculated for each input image so that brightness of each input image is maintained to be a desired brightness.

For instance, in the case where the AE score of the input image at time tᵢ is AEᵢ and a reference AE score set for realizing a desired brightness is AE_{REF}, if AE_{REF}=AEᵢ×2 holds, the AE control unit (or the main control unit 51) sets the signal amplification factor G_{TOTAL} when the input image after time tᵢ is obtained, so that the signal amplification factor G_{TOTAL} when the input image at time tᵢ₊ⱼ is obtained becomes twice of that when the input image at time t, is obtained. The symbol j is usually two or larger, and the signal amplification factor G_{TOTAL}, is changed gradually toward a target value over a few frames, but j may be one. On the contrary, if AE_{REF}=AEᵢ/2 holds, the AE control unit (or the main control unit 51) sets the signal amplification factor G_{TOTAL} when the input image after time tᵢ is obtained, so that the signal amplification factor G_{TOTAL} when the input image at time tᵢ₊ⱼ is obtained becomes ½ of that when the input image at time tᵢ is obtained.

Note that it is possible to set the signal amplification factor G_{TOTAL} in accordance with a user's instruction. If the user instructs to specify the signal amplification factor G_{TOTAL}, the signal amplification factor G_{TOTAL}, is determined in accordance with the user's instruction regardless of the AE score. For instance, the user can specifies the signal amplification factor G_{TOTAL} directly by using the operation part 26. In addition, for example, the user can specify the signal amplification factor G_{TOTAL} by specifying the ISO sensitivity using the operation part 26. The ISO sensitivity indicates sensitivity defined by International Organization for Standardization (ISO), and the user can adjust brightness (luminance level) of the input image, and thus brightness of the output image, by adjusting the ISO sensitivity. When the ISO sensitivity is determined, the signal amplification factor G_{TOTAL}, is determined uniquely. When the ISO sensitivity increases twice from a certain state, the signal amplification factor G_{TOTAL} also increases twice.

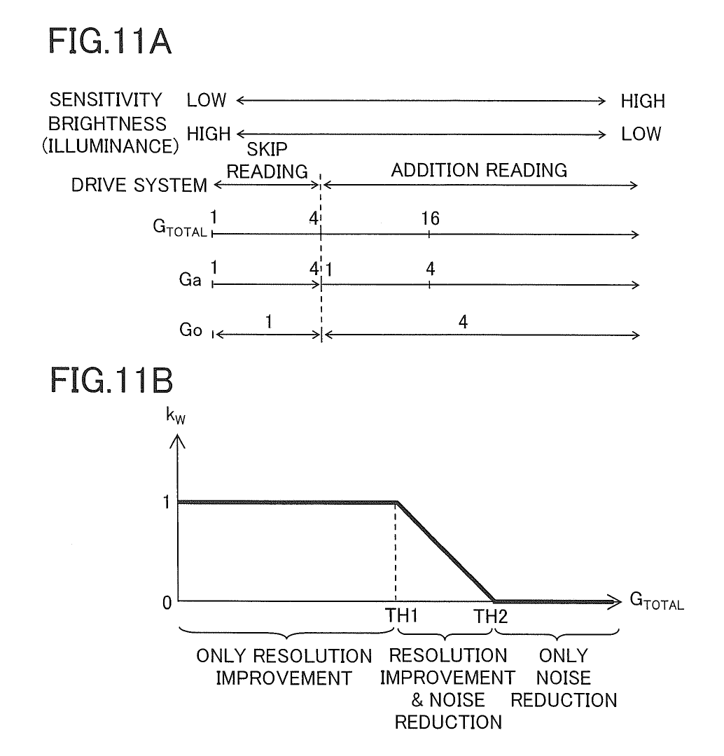

FIG. 11A illustrates a relationship among the various amplification factors G_{TOTAL}, Ga, and, Go and the drive system. FIG. 11B illustrates a relationship between the signal amplification factors G_{TOTAL} and the weight coefficient k_{W}. Basically, if the brightness of the subject is high, imaging sensitivity is set to be lower so that the signal amplification factor G_{TOTAL} becomes low. If the brightness of the subject is low, the imaging sensitivity is set to be higher so that the signal amplification factor G_{TOTAL} becomes high.

As illustrated in FIG. 11A, in Example 1, on the basis that the amplification factor Go is four when the addition reading is performed, the input image is generated by the skip reading when the G_{TOTAL} is smaller than four, while the input image is generated by the addition reading when the G_{TOTAL} is four or larger. In addition, as illustrated in FIG. 11B, if a first inequality G_{TOTAL}<TH1 holds, the weight coefficient k_{W} is set to one. If a second inequality TH1≦G_{TOTAL}<TH2 holds, the weight coefficient k_{W} is decreased linearly (or non-linearly) from one to zero as G_{TOTAL} increases from TH1 to TH2. If a third inequality TH2≦G_{TOTAL} holds, the weight coefficient k_{W} is set to zero.

Therefore, when the first inequality G_{TOTAL}<TH1 holds, the noise reduced image has no contribution to the output image so that the image with improved resolution itself becomes the output image. When the third inequality TH2≦G_{TOTAL} holds, the image with improved resolution has no contribution to the output image so that the noise reduced image itself becomes the output image. When the second inequality TH1≦G_{TOTAL}<TH2 holds, the image with improved resolution and the noise reduced image contribute to generation of the output image. In the range where the second inequality TH1≦G_{TOTAL}<TH2 is satisfied, a contribution degree of the image with improved resolution to the output image becomes relatively larger than that of the noise reduced image as G_{TOTAL} is closer to TH1. A contribution degree of the noise reduced image to the output image becomes relatively larger than that of the image with improved resolution as G_{TOTAL} is closer to TH2. Note that also in the case where the weight coefficient k_{W} is one, it can be said that the contribution degree of the image with improved resolution to the output image (i.e., 100%) is relatively larger than the contribution degree of the noise reduced image (i.e., 0%). Also in the case where the weight coefficient k_{W} is zero, it can be said that the contribution degree of the noise reduced image to the output image (i.e., 100%) is relatively larger than the contribution degree of the image with improved resolution (i.e., 0%).

TH1 and TH2 are predetermined threshold values satisfying the inequality 4≦TH1<TH2. Therefore, when the image sensor 33 is driven by the skip reading, k_{W} is set to one. Corresponding to the setting of k_{W} to be one until the amplification factor Ga becomes four when the skip reading is performed, the threshold value TH1 is set to 16 so that k_{W} is set to one until the amplification factor Ga becomes 4 when the addition reading is performed. As a matter of course, the threshold value TH1 may be set to a value other than 16 (e.g., TH1 may be four).

As describe above, many folding noises are generated in the image data obtained by the skip reading method. The effect of the resolution improving process based on a plurality of images is larger when the skip reading is performed than when the addition reading is performed. However, noise becomes substantially large when the skip reading is performed when the signal amplification factor G_{TOTAL} is high, due to low illuminance or the like. Therefore, in this case, it is more useful to try to reduce a signal-to-noise ratio (SN ratio) by the addition reading, for improving image quality of the entire moving image. Considering this, in Example 1, if the signal amplification factor G_{TOTAL} is low due to high illuminance or the like, the skip reading is performed, and the resolution improving process is made to have large contribution to the output image. On the other hand, if the signal amplification factor G_{TOTAL} is high due to low illuminance or the like, the addition reading is performed, and the noise reduction process is made to have large contribution to the output image. Thus, it is possible to generate an output image sequence in which both the effect of improving the resolution and the effect of reducing noise can be achieved in balance.

### Example 2

Example 2 will be described. In Example 2, the main control information given to the main control unit 51 illustrated in FIG. 8 is brightness information corresponding to brightness of the subject of the image sensing apparatus 1. The brightness of the subject of the image sensing apparatus 1 may be read as illuminance of the image sensing apparatus 1 illuminating the subject.

The above-mentioned brightness information defines the brightness control value B_{CONT}. A relationship between the brightness control value B_{CONT} and the amplification factor Ga in the AFE 12 and the amplification factor Go depending on the drive system of the image sensor 33 is expressed by the following equation.

B_{CONT}=Ga×Go

The brightness control value B_{CONT} can be determined from the above-mentioned AE score. The quotient obtained by dividing the AE score of the input image at time tᵢ by the product Ga×Go increases as the brightness of the subject at time tᵢ increases, while it decreases as the brightness of the subject at time tᵢ decreases.

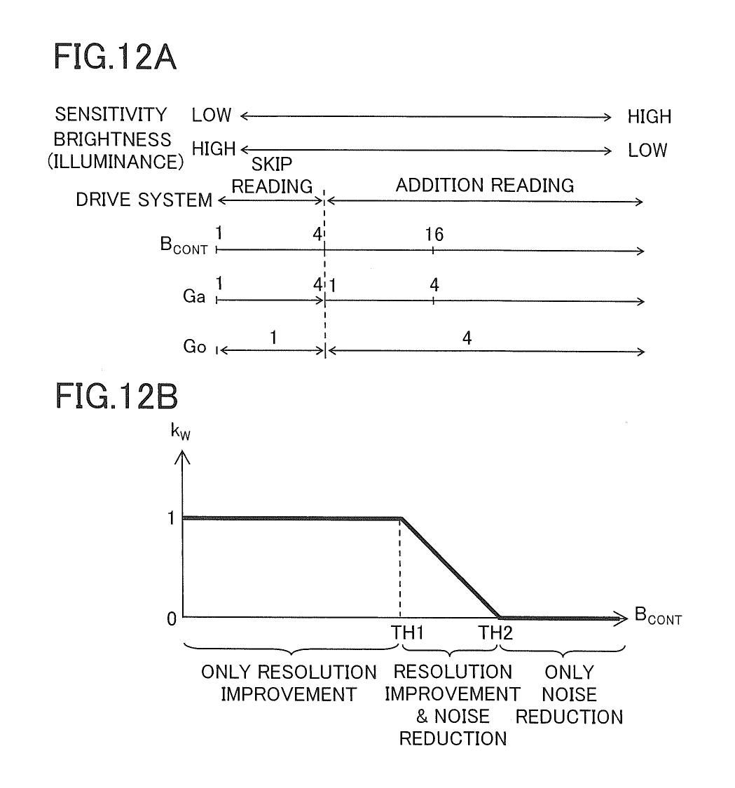

For convenience sake, it is supposed that the brightness control value B_{CONT} is determined so that the brightness control value B_{CONT} decreases as the brightness of the subject increases. For instance, the reciprocal number itself of the above-mentioned quotient or a value depending on the reciprocal number may be used as the brightness control value B_{CONT}. Further, normalization is performed so that a minimum value that the brightness control value B_{CONT} can have becomes one. Then, a relationship among B_{CONT}, Ga, Go, and the drive system becomes as illustrated in FIG. 12A, while a relationship between B_{CONT} and k_{W} becomes as illustrated in FIG. 12B. In other words, a relationship among B_{CONT}, Ga, Go, and the drive system, and a relationship between B_{CONT} and k_{W} are respectively the same as the relationship among the G_{TOTAL}, Ga, Go, and the drive system, and the relationship between G_{TOTAL} and k_{W}, described above with reference to FIGS. 11A and 11B.

When the description in Example 1 is applied to Example 2, it is sufficient to read the signal amplification factor G_{TOTAL} in Example 1 as the brightness control value B_{CONT}. In other words, in Example 2, if B_{CONT} is smaller than four because the brightness of the subject is relatively high, the input image is generated by the skip reading. If B_{CONT} is four or larger because the brightness of the subject is relatively low, the input image is generated by the addition reading. In addition, when a first inequality B_{CONT}<TH1 holds, the weight coefficient k_{W} is set to one. If a second inequality TH1≦B_{CONT}<TH2 holds, the weight coefficient k_{W} is decreased linearly (or non-linearly) from one to zero as B_{CONT} increases from TH1 to TH2. If a third inequality TH2≦B_{CONT} holds, the weight coefficient k_{W} is set to zero.

Therefore, when the inequality B_{CONT}<TH1 holds, the noise reduced image has no contribution to the output image so that the image with improved resolution itself becomes the output image. When the third inequality TH2≦B_{CONT} holds, the image with improved resolution has no contribution to the output image so that the noise reduced image itself becomes the output image. When the second inequality TH1≦B_{CONT}<TH2 holds, the image with improved resolution and the noise reduced image contribute to generation of the output image. In the range where the second inequality TH1≦B_{CONT}<TH2 is satisfied, a contribution degree of the image with improved resolution to the output image becomes relatively larger than that of the noise reduced image as B_{CONT} is closer to TH1. A contribution degree of the noise reduced image to the output image becomes relatively larger than that of the image with improved resolution as B_{CONT} is closer to TH2.

In addition, if a light measuring sensor (not shown) for measuring brightness of the subject is provided to the image sensing apparatus 1, a value based on the output signal of the light measuring sensor may be used as a brightness control value B_{CONT}. The light measuring sensor detects incident light amount to the image sensor 33 per unit time so as to measure the brightness of the subject and output a signal indicating the measurement result. In the case where the brightness control value B_{CONT} is determined from the output signal of the light measuring sensor, as described above, the brightness control value B_{CONT} is determined so that the brightness control value B_{CONT} is decreased as the brightness of the subject increases, and the normalization is performed so that a minimum value that the brightness control value B_{CONT} can have becomes one.

Also in Example 2, if the brightness control value B_{CONT} is low due to high illuminance or the like, the skip reading is performed, and the resolution improving process is made to have large contribution to the output image. On the other hand, if the brightness control value B_{CONT} is high due to low illuminance or the like, the addition reading is performed, and the noise reduction process is made to have large contribution to the output image. Thus, similarly to Example 1, it is possible to generate an output image sequence in which both the effect of improving the resolution and the effect of reducing noise can be achieved in balance.

Note that the method of setting the brightness control value B_{CONT} in which “the brightness control value B_{CONT} decreases as the brightness of the subject increases” is merely an example considering compatibility with Example 1, and it is possible to adopt the opposite increasing and decreasing relationship.

### Example 3

Example 3 will be described. In Example 1 or Example 2 described above, the drive system of the image sensor 33 is switched simply between the skip reading method and the addition reading method with respect to a certain constant imaging sensitivity or a certain constant brightness of the subject. However, it is possible to use both the skip reading method and the addition reading method by time sharing around the boundary. Example 3 realizes the combination use. The description in Example 1 or Example 2 is also applied to Example 3 unless otherwise described.

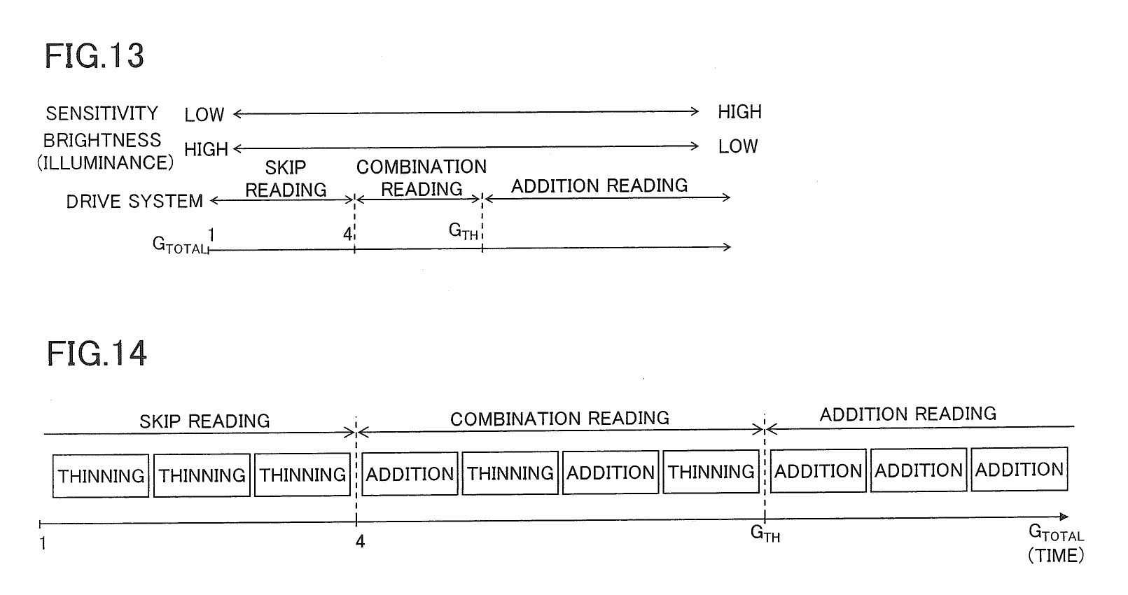

For specific description, an operation in the case where the sensitivity information in Example 1 is used as the main control information will be described. FIG. 13 illustrates a relationship between G_{TOTAL} and the drive system according to Example 3.

As illustrated in FIG. 13, if G_{TOTAL} is smaller than four, the input image is generated by the skip reading. If G_{TOTAL} is a predetermined threshold value G_{TH} or larger, the input image is generated by the addition reading. If G_{TOTAL} satisfies the inequality 4≦G_{TOTAL}<G_{TH}, the input image is generated by the combination reading. The symbol G_{TH} denotes a predetermined threshold value that is larger than four. Although not described in Example 1 particularly, if G_{TOTAL} is maintained to be smaller than four in a certain period, all the input images taken in the period are generated by the skip reading. Similarly, when G_{TOTAL} is maintained to be G_{TH} or larger in a certain period, all the input images taken in the period are generated by the addition reading.

The combination reading means reading that is performed in the state where the skip reading and the addition reading are mixed. However, to be mixed in this case means not the case where the skip reading and the addition reading are performed simultaneously (or in combination) when one input image is generated but the case where the skip reading and the addition reading are performed by time sharing. For instance, in the combination reading, the skip reading and the addition reading are performed alternately.

FIG. 14 is an image diagram illustrating a manner in which the drive system of the image sensor 33 changes. The horizontal axis in FIG. 14 represents G_{TOTAL}. Here, it is supposed that G_{TOTAL} increases from one as time lapses (alternatively, it is possible to suppose the state where G_{TOTAL} is decreased toward one as time lapses). In this case, the horizontal axis in FIG. 14 also represents time. As illustrated in FIG. 14, the skip reading is performed continuously in a first period satisfying G_{TOTAL}<4, so that the input image sequence based on the skip reading is obtained. In a second period satisfying 4≦G_{TOTAL}<G_{TH}, the combination reading is performed. In the example illustrated in FIG. 14, the skip reading and the addition reading are performed alternately in the second period. As a result, the input image based on the skip reading and the input image based on the addition reading are obtained alternately. In a third period satisfying G_{TH}≦G_{TOTAL}, the addition reading is performed continuously so that the input image sequence based on the addition reading is obtained.

As described above in Example 1, G_{TOTAL} satisfies G_{TOTAL}=Ga×Go. On the other hand, the amplification factor Go depending on the drive system is one when the skip reading is performed while it is four when the addition reading is performed. Therefore, in the second period where the combination reading is performed, amplification factor Go changes between one and four. Accompanying this, the amplification factor Ga of the AFE 12 increases or decreases discontinuously.

Although the operation in the case where the sensitivity information according to Example 1 is used is described above, the same is true in the case where the brightness information according to Example 2 is used. In other words, G_{TOTAL} described above in Example 3 may be read as B_{CONT}.

Further, in the above description, the skip reading and the addition reading are performed alternately in the second period where the combination reading is performed. In other words, the skip reading and the addition reading are performed at a ratio of 1:1. However, the ratio may not be 1:1. For instance, if the ratio is set to 2:1, an operation including two continuous times of obtaining of the input image by the skip reading and then one obtaining of the input image by the addition reading is performed repeatedly in the second period. If the ratio is set to 1:2, an operation including one obtaining of the input image by the skip reading and then two continuous times of obtaining of the input image by the addition reading is performed repeatedly in the second period. The above-mentioned ratio may be changed in accordance with G_{TOTAL} or B_{CONT}. For instance, in the second period, the ratio may be changed from 2:1 to 1:2 via 1:1 as G_{TOTAL} or B_{CONT} increases.

An image quality difference may be occurred between the image obtained by the skip reading and the image obtained by the addition reading. By using the above-mentioned combination reading, a rapid change of the image quality that may occur when switching between the continuous drive of the skip reading and the continuous drive of the addition reading is performed is relieved.

### Example 4

Example 4 will be described. It is possible to perform the resolution improving process and the noise reduction process without considering whether the input images to be combined include only the input images based on the skip reading, or include only the input images based on the addition reading, or include the input image based on the skip reading and the input image based on the addition reading. In other words, for example, among three input images INᵢ₋₂ to INᵢ to be combined, even if two images are input images based on the skip reading and the other one is the input image based on the addition reading, it is possible to perform the resolution improving process and the noise reduction process similarly to the case where they are all the input images based on the skip reading. However, by this method, the image quality change may be conspicuous in the part where the drive system is switched. In Example 4, the method in which the object to be combined is devised so as to suppress the image quality change will be described.

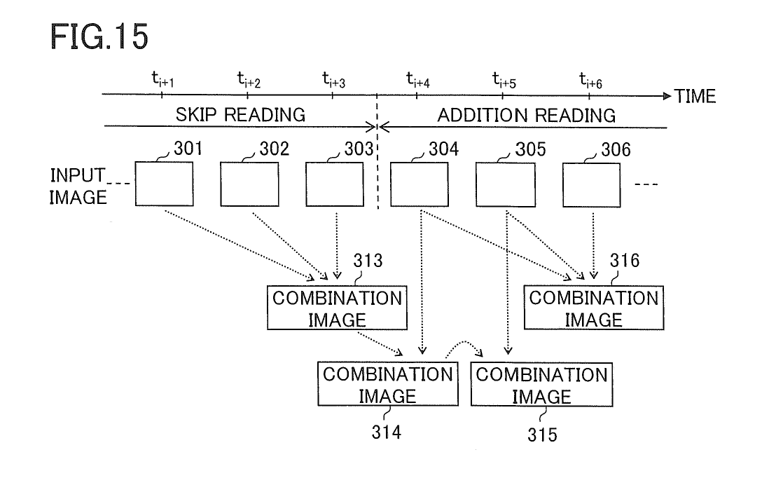

Here, it is supposed that six input images 301 to 306 as illustrated in FIG. 15 are obtained continuously, and the resolution improving process according to Example 4 will be described. The input images 301 to 303 are input images obtained by the skip reading, and the input images 304 to 306 are input images obtained by the addition reading. The input images 301, 302, 303, 304, 305, and 306 correspond to input images at times tᵢ₊₁, tᵢ₊₂, tᵢ₊₃, tᵢ₊₄, tᵢ₊₅, and tᵢ₊₆, respectively.

In this case, the resolution improvement processing unit 54 generates a combination image 313 by combining the input images 301 to 303 so that folding noises in the images to be combined (301 to 303) are reduced, by the resolution improving process based on a displacement amount between the input images 301 and 302, and a displacement amount between the input images 302 and 303;

generates a combination image 314 by combining the combination image 313 and the input image 304 so that folding noises in the images to be combined (313 and 304) are reduced, by the resolution improving process based on a displacement amount between the combination image 313 and the input image 304;

generates a combination image 315 by combining the combination image 314 and the input image 305 so that folding noises in the images to be combined (314 and 305) are reduced, by the resolution improving process based on a displacement amount between the combination image 314 and the input image 305;

and

generates a combination image 316 by combining the input images 304 to 306 so that folding noises in the images to be combined (304 to 306) are reduced, by the resolution improving process based on a displacement amount between the input images 304 and 305 and a displacement amount between the input images 305 and 306. Then, the combination images 313, 314, 315, and 316 are output as the images with improved resolution at time tᵢ₊₃, tᵢ₊₄, tᵢ₊₅, and tᵢ₊₆ respectively.

Note that the combination of the input images 301 to 303 is performed with reference to the input image 303 as the latest input image. Therefore, as the displacement amount between the combination image 313 and the input image 304, the displacement amount between the input images 303 and 304 can be used. Similarly, the combination of the combination image 314 and the input image 305 is performed with reference to the input image 305 as the latest input image. Therefore, as the displacement amount between the combination image 314 and the input image 305, the displacement amount between the input images 304 and 305 can be used.

The combination method of a plurality of images to be used in the resolution improving process is described above, and the similar combination method can be used in the noise reduction process of the noise reduction processing unit 55.

According to the combination method of Example 4, in the part where the drive system is switched, image quality change (image quality change due to switching of the drive system) of the image with improved resolution and noise reduced image, and thus the output image can be relieved.

### Example 5

Example 5 will be described. In Example 5, another method of relieving the image quality change in the part where the drive system is switched will be described.

It is supposed that six input images 301 to 306 as illustrated in FIG. 15 are obtained continuously, and the resolution improving process according to Example 5 will be described. As described above in Example 4, the input images 301 to 303 are input images obtained by the skip reading, while the input images 304 to 306 are input images obtained by the addition reading.

In the resolution improving process based on the three input image, corresponding pixel signals in three input images are mixed at a mixing ratio based on the displacement amounts among the three input images, so that the pixel signals of the image with improved resolution are generated. For instance, in the case where the images to be combined are the input images 301 to 303, it is supposed that the mixing ratio among the input image 301, 302, and 303 is determined to be 1:1:8 on the basis of the displacement amounts among the input images 301, 302, and 303. Then, the pixel signal of the input image 301, the pixel signal of the input image 302, and the pixel signal of the input image 303 corresponding to the pixel position [x,y] of the image with improved resolution are mixed at the mixing ratio 1:1:8, so as to generate the pixel signal of the image with improved resolution at the pixel position [x,y]. The image with improved resolution based on the input images 301, 302, and 303 are the image with improved resolution at time tᵢ₊₃. Since the input images 301, 302, and 303 are all the input images based on the skip reading, a contribution ratio of the skip reading to the image with improved resolution at time tᵢ₊₃ is 100% in this example.

Further, in the resolution improving process, it is supposed that the mixing ratio of the input images 302, 303, and 304 is determined to be 1:1:8 on the basis of the displacement amounts among the input images 302, 303, and 304. If the pixel signal of the input image 302, the pixel signal of the input image 303, and the pixel signal of the input image 304 corresponding to the pixel position [x,y] of the image with improved resolution are mixed in the mixing ratio 1:1:8, a contribution ratio of the skip reading to the combination image generated as the image with improved resolution at time tᵢ₊₄ becomes 20%, while a contribution ratio of the addition reading becomes 80%. Then, the image with improved resolution at time tᵢ₊₄ becomes to have largely the characteristic of the addition reading. As a result, the image quality change may be steep in the part where the drive system is switched.

In order to avoid this, in Example 5, in the process of changing the drive system from the skip reading to the addition reading, the contribution ratio of the skip reading to the image with improved resolution is changed gradually (the same is true in the process of changing the drive system from the addition reading to the skip reading).

For instance, the combination process should be performed so that the contribution ratio of the skip reading to the image with improved resolution at time tᵢ₊₄ does not become lower than a lower limit value L_{LIM1}. More specifically, for example, in the case where the mixing ratio among the input images 302, 303, and 304 is determined to be 1:1:8 on the basis of the displacement amounts among the input images 302, 303, and 304, if L_{LIM1} is set to 0.6, the above-mentioned mixing ratio is corrected to be 3:3:4, the pixel signal of the input image 302, the pixel signal of the input image 303, and the pixel signal of the input image 304 corresponding to the pixel position [x,y] of the image with improved resolution should be mixed at the mixing ratio 3:3:4, so that the pixel signal at the pixel position [x,y] of the image with improved resolution at time tᵢ₊₄ is generated.

Similarly, the combination process should be performed so that the contribution ratio of the skip reading to the image with improved resolution at time tᵢ₋₅ does not become lower limit value L_{LIM2}. More specifically, for example, in the case where the mixing ratio among the input images 303, 304, and 305 are determined to be 1:5:5 on the basis of the displacement amounts among the input images 303, 304, and 305, if L_{LIM2} is set to 0.2, the above-mentioned mixing ratio is corrected to be 2:4:4, and the pixel signal of the input image 303, the pixel signal of the input image 304, and the pixel signal of the input image 305 corresponding to the pixel position [x,y] of the image with improved resolution should be mixed at the mixing ratio 2:4:4, so that generate the pixel signal at the pixel position [x,y] of the image with improved resolution at time tᵢ₊₅.

The lower limit values L_{LIM1} and L_{LIM2} are larger than 0 and are smaller than one. Therefore, the contribution ratio of the input image before the drive system is changed (input image based on the skip reading in this example) to the image with improved resolution just after the drive system is changed (images with improved resolution at times tᵢ₊₄ and tᵢ₊₅ in this example) is secured to be a constant ratio or larger. The lower limit values L_{LIM1} and L_{LIM2} may be the same value, but is it desirable that the lower limit values L_{LIM1} and L_{LIM2} are set so that 0<L_{LIM2}<L_{LIM1}<1 is satisfied for realizing a smooth ratio change.

Although the combination method of a plurality of images which is used in the resolution improving process is described above, the same combination method may be used in the noise reduction process performed by the noise reduction processing unit 55.

According to the combination method of Example 5, in the part where the drive system is switched, image quality change (image quality change due to switching of the drive system) of the image with improved resolution and noise reduced image, and thus the output image can be relieved.

### Example 6

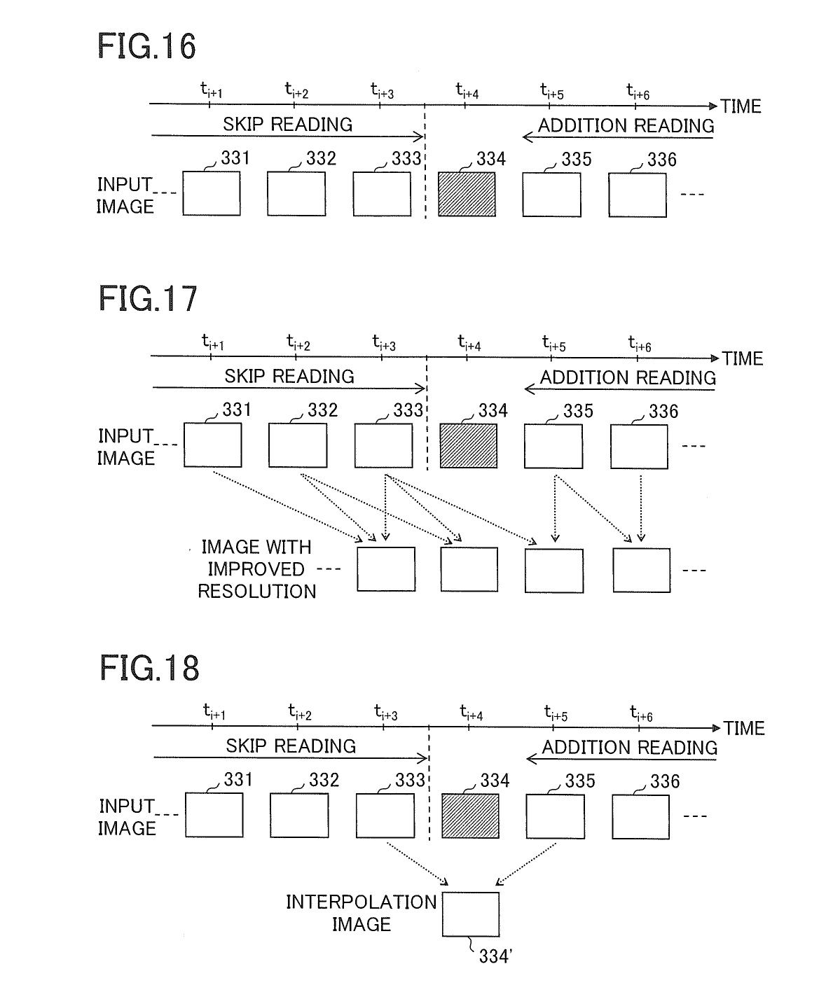

Example 6 will be described. In the above descriptions, it is supposed that no invalid frame is generated when the drive system is switched. The invalid frame means a frame in which the effective light receiving pixel signal cannot be obtained temporarily from the image sensor 33 when the drive system is switched. There are a case where the invalid frame is generated and the case where the invalid frame is not generated in accordance with characteristic of the image sensor 33. In Example 6, as illustrated in FIG. 16, it is supposed that an invalid frame is generated when the drive system is switched.

It is supposed that the input image 331, 332, 333, 335, and 336 as illustrated in FIG. 16 are obtained successively, and the resolution improving process according to Example 6 will be described. The input images 331 to 333 are input images obtained by the skip reading, and the input images 335 and 336 are input images obtained by the addition reading. The input images 331, 332, 333, 335, and 336 correspond to input images at times tᵢ₊₁, tᵢ₊₃, tᵢ₊₅, and tᵢ₊₆. The numeral 334 denotes the invalid frame. Fundamentally, the input image by the addition reading at time tᵢ₊₄ must be obtained by imaging at time tᵢ₊₄. However, because a constant time is necessary for changing the drive system, the input image at time tᵢ₊₄ is missing, so that the invalid frame 334 is generated.

As described above, the resolution improvement processing unit 54 generates one image with improved resolution from three input images that are temporally continuous, in principle. However, if the invalid frame 334 is generated, the resolution improvement processing unit 54 can generate images with improved resolution from time tᵢ₊₄ to time tᵢ₊₆ by one of first to third invalid frame supporting methods described below.

The first invalid frame supporting method will be described. FIG. 17 is an image diagram of a first invalid frame supporting method. In the first invalid frame supporting method, relatively a few input images except the invalid frame are used for performing the resolution improving process. In other words, as illustrated in FIG. 17, the input image 332 and 333 are combined by the resolution improving process based on the displacement amount between the input images 332 and 333, and the obtained combination image is generated as the image with improved resolution at time tᵢ₊₄. Then, the input images 333 and 335 are combined by the resolution improving process based on the displacement amount between the input images 333 and 335, and the obtained combination image is generated as the image with improved resolution at time tᵢ₊₅. Further, the input images 335 and 336 are combined by the resolution improving process based on the displacement amount between the input images 335 and 336, and the obtained combination image is generated as the image with improved resolution at time tᵢ₊₆.

It is possible to use the method of Example 5 as the first invalid frame supporting method. In this case, for example, the combination process is performed so that the contribution ratio of the skip reading to the image with improved resolution at time tᵢ₊₅ does not become lower than a predetermined lower limit value L_{LIM3} (0<L_{LIM3}<1). In other words, in the case where it is decided that the mixing ratio of the input images 333 and 335 is 1:4 on the basis of the displacement amount between the input images 333 and 335, if L_{LIM3} is set to 0.5, the above-mentioned mixing ratio may be corrected to be 1:1, and the pixel signal of the input image 333 and the pixel signal of the input image 335 corresponding to the pixel position [x,y] of the image with improved resolution at time tᵢ₊₅ may be mixed at the mixing ratio 1:1 so as to generate the pixel signal at the pixel position [x,y] in the image with improved resolution at time tᵢ₊₅.

A second invalid frame supporting method will be described. In the second invalid frame supporting method, at timing when the invalid frame is handled as a reference image of the resolution improving process, the combination image that is generated just before is output repeatedly. The timing when the invalid frame is handled as a reference image of the resolution improving process means timing when the invalid frame becomes the latest frame, which is time tᵢ₊₄ in the example illustrated in FIG. 16 or 17. Therefore, in the second invalid frame supporting method, the image with improved resolution at time tᵢ₊₃ based on the input images 331 to 333 is output again as it is to the weighted addition unit 56 as the image with improved resolution at time tᵢ₊₄. The generation method of the images with improved resolution at time tᵢ₊₅ and tᵢ₊₆ can be the same as that described above in the first invalid frame supporting method.

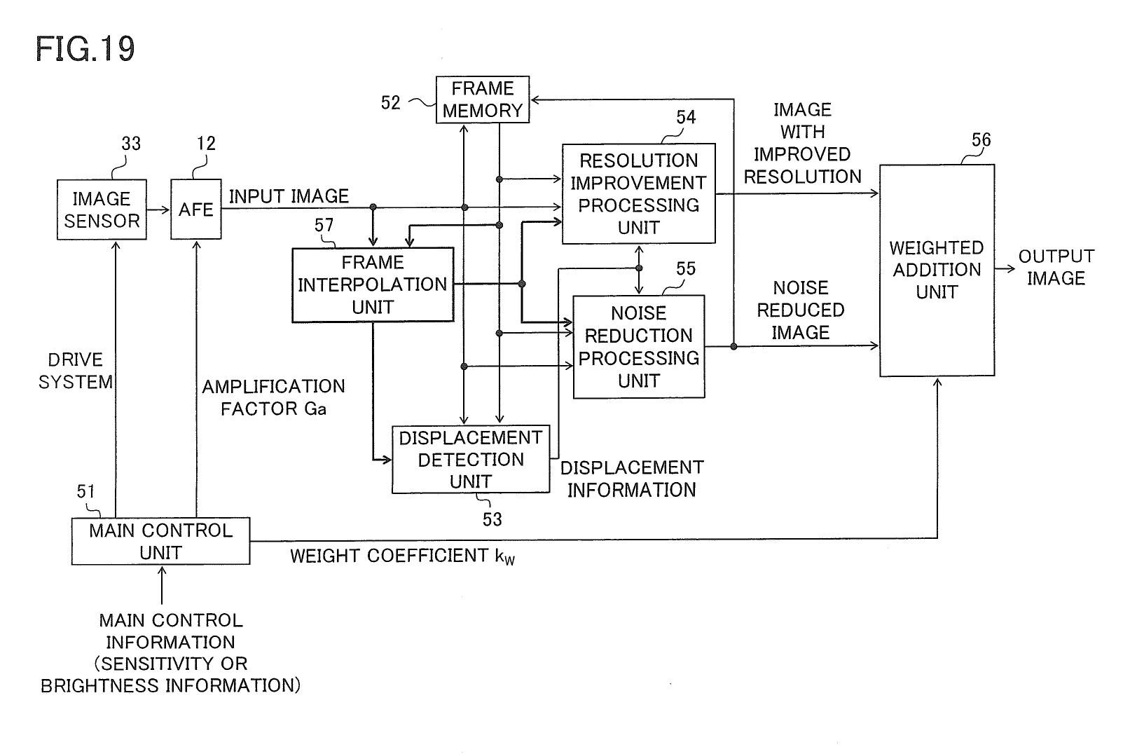

A third invalid frame supporting method will be described. FIG. 18 is an image diagram of the third invalid frame supporting method. In the third invalid frame supporting method, interpolation of the input image corresponding to the invalid frame is performed by using frames before and/or after the invalid frame. When the third invalid frame supporting method is adopted, the block diagram illustrated in FIG. 8 is changed to the block diagram illustrated in FIG. 19. The block diagram illustrated in FIG. 19 is the same as what is obtained by adding a frame interpolation unit 57 to the block diagram illustrated in FIG. 8. The frame interpolation unit 57 may be disposed in the video signal processing unit 13 illustrated in FIG. 1. The frame interpolation unit 57 is generated the input image corresponding to the invalid frame by interpolation using the input image of the frame just before the invalid frame and/or the input image of the frame just after the invalid frame.

Specifically, if the invalid frame 334 is generated at time tᵢ₊₄, the frame interpolation unit 57 generates the input image 333 itself or the input image 335 itself as an interpolation image 334′. Alternatively, it generates a combination image of the input images 333 and 335 as the interpolation image 334′. The interpolation image 334′ is handled as the input image at time tᵢ₊₄ and is supplied to the resolution improvement processing unit 54 and the like.

When the interpolation image 334′ is generated by combining the input images 333 and 335, a simple average combination or a motion compensation combination can be used. In the simple average combination, an average of the pixel signal of the input image 333 and the pixel signal of the input image 335 is calculated simply so as to generate the corresponding pixel signal in the interpolation image 334′. In the motion compensation combination, an image at timing of the invalid frame 334 is estimated from an optical flow between the input images 333 and 335, so as to generate the image after the motion compensation as the interpolation image 334′ from the input images 333 and 335. Since the method of the motion compensation is known, detailed description thereof will be omitted.

The invalid frame supporting method that is used in the resolution improving process is described above, but the same method can be applied to the noise reduction process performed by the noise reduction processing unit 55.

According to Example 6, an appropriate image with improved resolution, an appropriate noise reduced image, and an appropriate output image can be generated even if an invalid frame occurs.

### Example 7

Example 7 will be described. In the above description, it is supposed that one weight coefficient k_{W} is used commonly to the entire image when one output image is generated. In Example 7, however, when one output image is generated, a plurality of weight coefficients having different values (hereinafter referred to as region weight coefficients) is used.

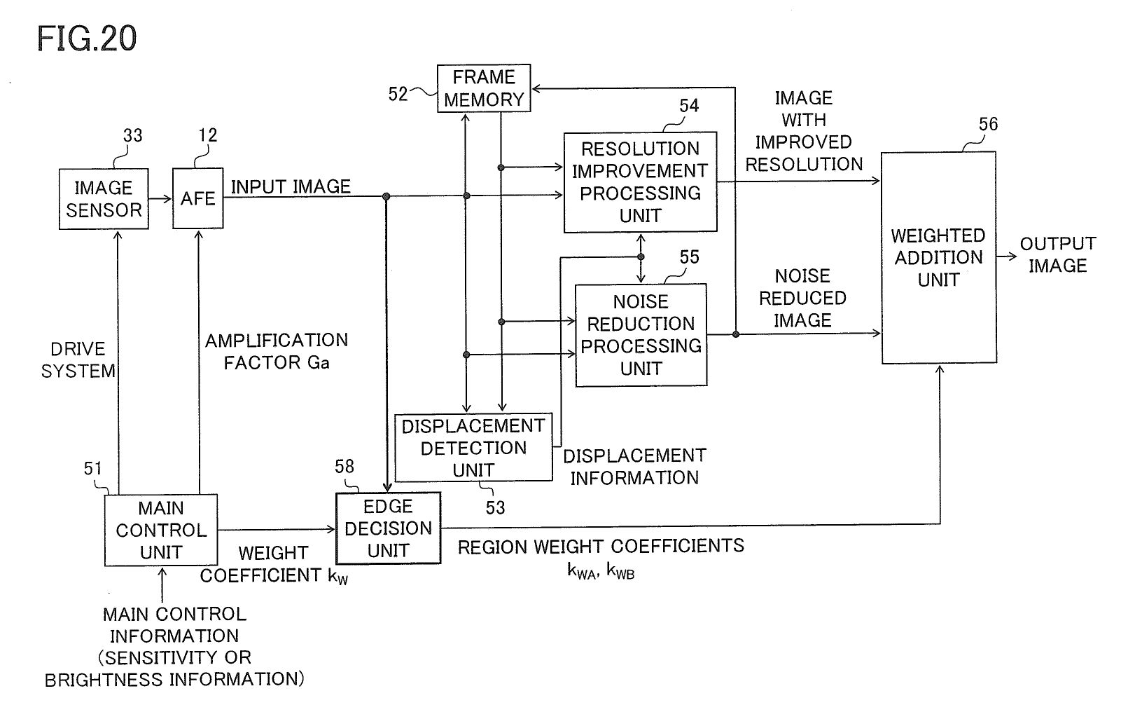

FIG. 20 is a block diagram of a part of the image sensing apparatus 1 according to Example 7. The block diagram illustrated in FIG. 20 is the same as what is obtained by adding an edge decision unit 58 to the block diagram illustrated in FIG. 8. The edge decision unit 58 may be disposed in the video signal processing unit 13 illustrated in FIG. 1.

Image data of the input image at each time is supplied to the edge decision unit 58. The edge decision unit 58 separates a whole image region of the input image into an edge region and a flat region for each input image on the basis of the image data of the input image. The edge region means an image region having a relatively large density change on the spatial domain, while the flat region means an image region having a relatively small density change on the spatial domain. A known arbitrary method can be used as the method of separating between the edge region and the flat region.

Specifically, for example, a whole image region of the input image is divided into a plurality of small blocks, and an edge score is calculated for each small block. Spatial domain filtering with an edge extraction filter such as a differential filter is performed on each pixel position in a noted small block, an absolute value of an output value of the edge extraction filter of each pixel position in the noted small block is accumulated, so that the obtained accumulated value is regarded as the edge score of the noted small block. Then, the small blocks are classified so that small blocks having the edge score larger than or equal to a predetermined reference score belong to the edge region and that small blocks having the edge score smaller than the reference score belong to the flat region. Thus, a whole image region of the input image can be separated into the edge region and the flat region.

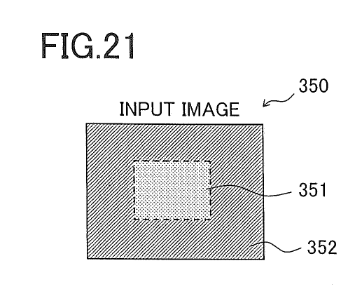

The edge decision unit 58 generates the region weight coefficient k_{WA} of the edge region and the region weight coefficient k_{WB} of the flat region from the weight coefficient k_{W} for each input image. For instance, it is supposed that a whole image region of the input image 350 illustrated in FIG. 21 is classified into the edge region 351 corresponding to the dotted region and the flat region 352 corresponding to the hatched region. In this case, the edge decision unit 58 generates the region weight coefficient k_{WA} of the edge region 351 and the region weight coefficient k_{WB} of the flat region 352 from the weight coefficient k_{W} of the input image 350 so that k_{WA}>k_{WB} is satisfied. For instance, k_{WA} and k_{WB} are determined so that k_{WA}=k_{W} and k_{WB}=k_{W}−Δk_{W} are satisfied, or k_{WA}=k_{W}+Δk_{W} and k_{WB}=k_{W}−Δk_{W} are satisfied under the condition that both the k_{WA} and k_{WB} become zero or larger and one or smaller (here, Δk_{W} is a predetermined value of zero or larger).

It is supposed that the input image 350 is the input image at time tᵢ. Then, when the weighted addition unit 56 illustrated in FIG. 20 generates the output image at time tᵢ, it generates the pixel signal of the output image in accordance with V_{OUT}[x,y]=k_{WA}×V_{A}[x,y]+(1−k_{WA})×V_{B}[x,y] for the image region corresponding to the edge region 350, and generates the pixel signal of the output image in accordance with V_{OUT}[x,y]=k_{WB}×V_{A}[x,y]+(1−k_{WB})×V_{B}[x,y] for the image region corresponding to the flat region 351. As described above, V_{B}[x,y], V_{B}[x,y] and V_{OUT}[x,y] respectively indicate the pixel signal at the pixel position [x,y] on the image with improved resolution at time tᵢ, the pixel signal at the pixel position [x,y] on the noise reduced image at time tᵢ, and the pixel signal at the pixel position [x,y] on the output image at time tᵢ.

Since the noise is more conspicuous visually in a flat part than in an edge part, it is desirable to enhance a noise reduction effect in the flat region than in the edge region. Example 7 supports this requirement.

Note that it is possible to change k_{WA} and/or k_{WB} in accordance with an edge degree in the edge region (e.g., in accordance with an average value of the edge scores in the edge region) or in accordance with a flat degree in the flat region (e.g., in accordance with an average value of the edge scores in the flat region).

In addition, in the example described above, a whole image region of the input image 350 is separated into two image regions, and different region weight coefficients are assigned to the image regions obtained by the separation. However, it is possible to separate a whole image region of the input image 350 into three or more image regions, and assign different region weight coefficients to the image regions obtained by the separation. One of the above-mentioned three or more image regions may be a face region in which image data of a human face exists.

In addition, it is possible to set the weight coefficient by pixel unit. The weight coefficient set by pixel unit is referred to as a pixel weight coefficient for convenience sake. When the weight coefficient is set by pixel unit, an edge amount is determined for each pixel position in the input image. The edge amount at the pixel position means intensity of density change of the image in the local region around the pixel position. In the input image, spatial domain filtering with an edge extraction filter such as a differential filter may be performed with respect to the noted pixel position so that the absolute value of the output value of the edge extraction filter with respect to the noted pixel position can be determined as the edge amount at the noted pixel position.

The edge amount and the pixel weight coefficient at the noted pixel position [x,y] are denoted by V_{EDGE}[x,y] and k[x,y], respectively, and a gain for weight gain_{EDGE}[x,y] is defined with respect to the noted pixel position [x,y]. The gain for weight gain_{EDGE}[x,y] is set in accordance with the edge amount V_{EDGE}[x,y] within the range satisfying the inequality gain_{L}≦gain_{EDGE}[x,y]≦gain_{H}″. Here, gain_{L}<1 and gain_{H}>1 are satisfied.

The edge decision unit 58 increases the gain for weight gain_{EDGE}[x,y] with respect to the noted pixel position [x,y] from gain_{L} to gain_{H} as the edge amount V_{EDGE}[x,y] with respect to the noted pixel position [x,y] increases. In other words, gain_{EDGE}[x,y] is made closer to gain_{H} as V_{EDGE}[x,y] is larger, while gain_{EDGE}[x,y] is made closer to gain_{L} as V_{EDGE}[x,y] is smaller. Then, the edge decision unit 58 decides the pixel weight coefficient k[x,y] with respect to the noted pixel position [x,y] in accordance with the following equation.

k[x,y]=k_{W}×gain_{EDGE}[x,y]

The pixel weight coefficient is determined for each pixel position of the input image. When the pixel weight coefficient is determined, the weighted addition unit 56 generates the output image at time t, using pixel weight coefficients having values that can be different for pixel positions, so as to generate the pixel signal of the output image in accordance with V_{OUT}[x,y]=k[x,y]×V_{A}[x,y]+(1−k[x,l])×V_{B}[x,y]. Thus, the pixel weight coefficient becomes relatively large with respect to the pixel position having a relatively large edge amount, so that the contribution degree of the image with improved resolution to the output image becomes relatively large. In contrast, the pixel weight coefficient becomes relatively small with respect to the pixel position having a small edge amount, so that the contribution degree of the noise reduced image to the output image becomes relatively large.

### Example 8

Example 8 will be described. In the above descriptions, it is supposed that the thinning pattern that is used for the skip reading is always the same, but it is possible to change the thinning pattern for each frame. The thinning pattern means a pattern of the light receiving pixels to be thinned when the light receiving pixel signal is read.

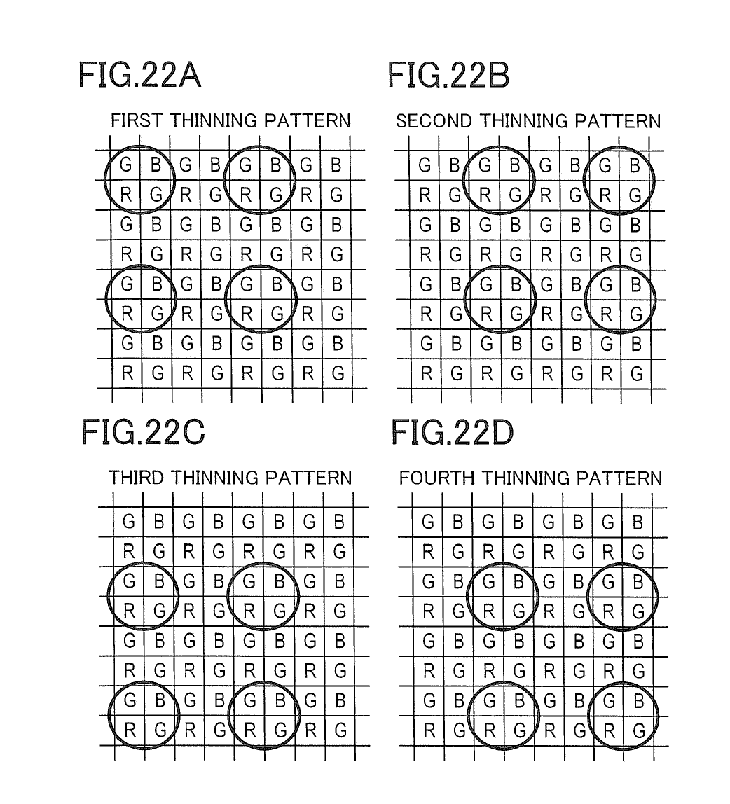

Specifically, for example, first, second, third, and fourth thinning patterns illustrated in FIGS. 22A to 22D can be used. In each of FIGS. 22A to 22D, the pixel signal of the light receiving pixel in circle frames are read out, while the light receiving pixels outside the circle frame are thinned. The light receiving pixels to be thinned are different among the first, second, third, and fourth thinning patterns.

When the small light receiving pixel region including sixteen light receiving pixels P_{S}[4p+1,4q+1] to P_{S}[4p+4,4q+4] is noted (p and q are natural numbers),

only the pixel signals of the light receiving pixels P_{S}[4p+1,4q+1], P_{S}[4p+2,4q+1], P_{S}[4p+1,4q+2], and P_{S}[4p+2,4q+2] are read out by the first thinning pattern,

only the pixel signals of the light receiving pixels P_{S}[4p+3,4q+1], P_{S}[4p+4,4q+1], P_{S}[4p+3,4q+2], and P_{S}[4p+4,4q+2] are read out by the second thinning pattern,

only the pixel signals of the light receiving pixels P_{S}[4p+1,4q+3], P_{S}[4p+2,4q+3], P_{S}[4p+1,4q+4], and P_{S}[4p+2,4q+4] are read out in the third thinning pattern, and

only the pixel signals of the light receiving pixels P_{S}[4p+3,4q+3], P_{S}[4p+4,4q+3], P_{S}[4p+3,4q+4], and P_{S}[4p+4,4q+4] are read out in the fourth thinning pattern.

In the period where the skip reading should be performed, the thinning pattern to be used is changed one by one among the above-mentioned four thinning patterns for performing the skip reading. Thus, it is possible to generate one image with improved resolution by the resolution improving process using four input images having different thinning patterns. For instance, if the period where the skip reading should be performed includes times tᵢ₊₁ to tᵢ₊₄, the skip reading is performed by the first, second, third, and fourth thinning patterns at times tᵢ₊₁, tᵢ₊₃, and tᵢ₊₄, respectively, so as to obtain the input images at times tᵢ₊₁, tᵢ₊₃, and tₜ₊₄. Thus, it is possible to generate the image with improved resolution at time tᵢ₊₄ by the resolution improving process based on the displacement amounts among the input images at times tᵢ₊₁ to tᵢ₊₄.

Sampling position when the analog optical image is sampled by the image sensor 33 is different among the first, second, third, and fourth thinning patterns. Therefore, the displacement amounts among the input images at times tᵢ₊₁ to tᵢ₊₄ are determined considering the difference of the sampling position among the first, second, third and fourth thinning patterns. As the resolution improving process based on the plurality of images obtained by using the plurality of different thinning patterns, a known method (e.g., the super-resolution process method described in JP-A-2009-124621) can be used.

Note that in the noise reduction processing unit 55, the noise reduction process should be performed after a process for canceling the above-mentioned difference of the sampling position. Alternatively, the noise reduction process should be performed considering the above-mentioned difference of the sampling position. In addition, in the example described above, the thinning pattern to be used is changed one by one among the four types of thinning patterns for performing the skip reading. However, the total number of the thinning patterns to be used may be any number of two or larger. For instance, in the period where the skip reading should be performed, it is possible to perform the skip reading by the first thinning pattern and the skip reading by the fourth thinning pattern alternately.

When the super-resolution process using the plurality of images is used in the resolution improving process, it is necessary that a position displacement of sub pixel unit is generated between neighboring frames. When a case (not shown) of the image sensing apparatus 1 is held by hands, it is expected that a position displacement of sub pixel unit is generated by hand shake. However, if the case of the image sensing apparatus 1 is fixed by a tripod or the like, such a position displacement may not be obtained. However, according to Example 8, since the sampling position changes between neighboring frames, good resolution improvement effect can be obtained even if the case of the image sensing apparatus 1 is fixed by a tripod or the like.

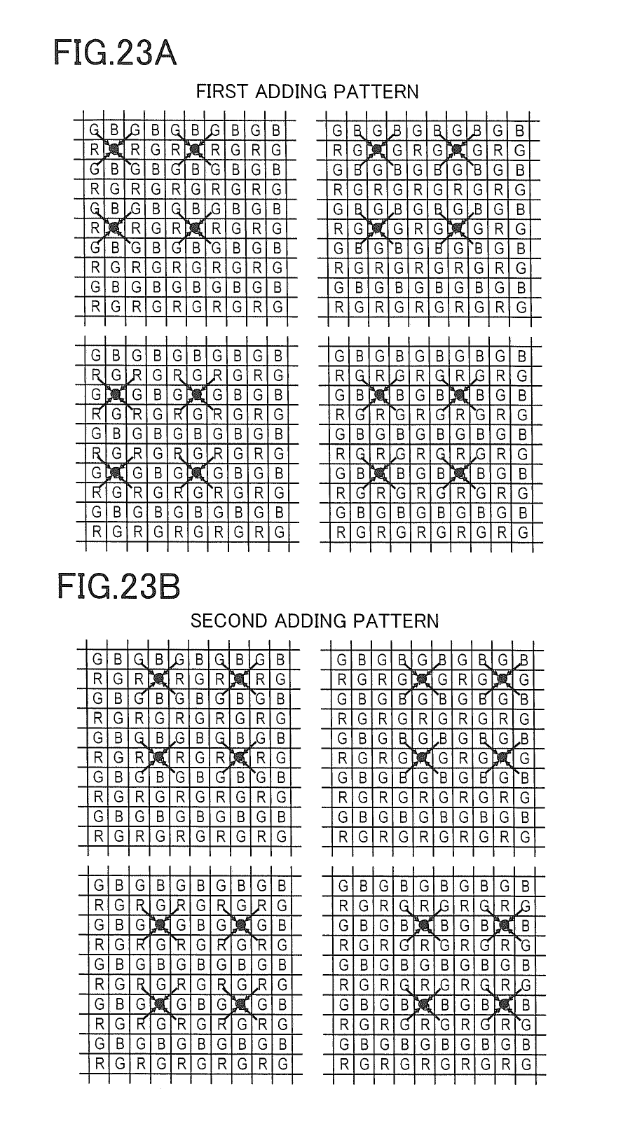

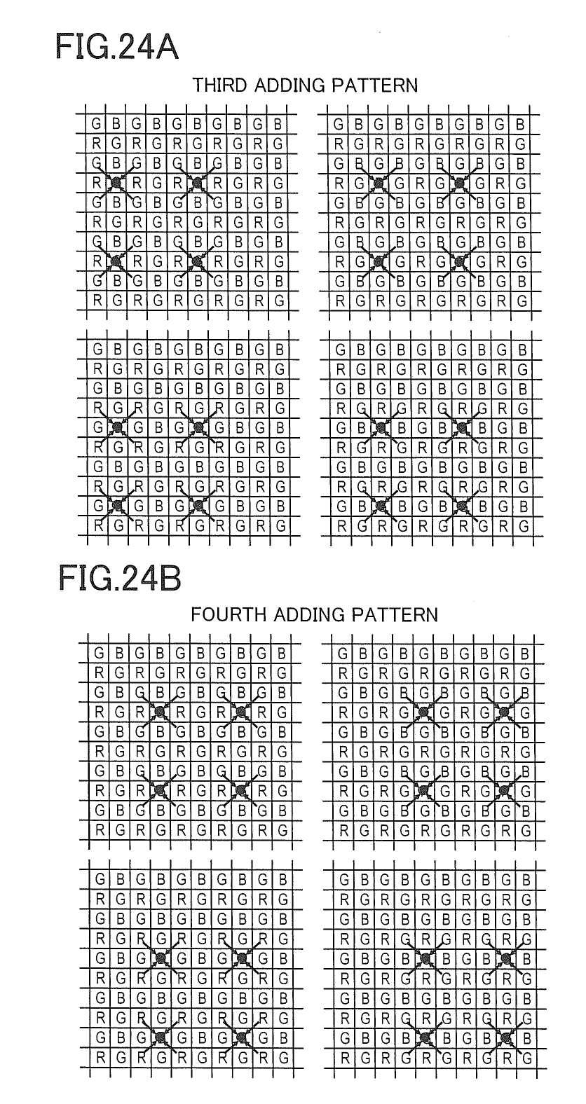

The method of changing the thinning pattern for each frame in the period where the skip reading should be performed is described above, but the same method can also be applied to the addition reading. In other words, the adding pattern may be changed for each frame in the period where the addition reading should be performed. The adding pattern means a combination pattern of the light receiving pixels to be added for generating the addition signal. For instance, a plurality of adding patterns described in JP-A-2009-124621 can be used (however, it should be noted that a positional relationship between the red filter and the blue filter is opposite between this embodiment and the embodiment described in JP-A-2009-124621). FIGS. 23A, 23B, 24A, and 24B illustrate first to fourth adding patterns that can be used in Example 8. FIG. 23A and the like illustrate manners in which pixel signals of four light receiving pixels positioned at sources of four arrows surrounding a black dot are added up.

The combination of the light receiving pixels to be targets of addition is different among the first, second, third, and fourth adding patterns. For instance, the pixel signal at the pixel position [1,1] on the original image is generated from:

the addition signal of the light receiving pixel signals of the light receiving pixels P_{S}[1,1], P_{S}[3,1], P_{S}[1,3], and P_{S}[3,3] when the first adding pattern is used;

the addition signal of the light receiving pixel signals of the light receiving pixels P_{S}[3,1], P_{S}[5,1], P_{S}[3,3], and P_{S}[5,3] when the second adding pattern is used;

the addition signal of the light receiving pixel signals of the light receiving pixels P_{S}[1,3], P_{S}[3,3], P_{S}[1,5], and P_{S}[3,5] when the third adding pattern is used; or

the addition signal of the light receiving pixel signals of the light receiving pixels P_{S}[3,3], P_{S}[5,3], P_{S}[3,5], and P_{S}[5,5] when the fourth adding pattern is used.

In the period where the addition reading should be performed, the adding pattern to be used may be changed one by one among the above-mentioned four adding patterns for performing the addition reading, so that one image with improved resolution can be generated by the resolution improving process using the four input images having different adding patterns. For instance, if the period where the addition reading should be performed includes times tᵢ₊₁ to tᵢ₊₄, the addition reading is performed by the first, second, third, and fourth adding patterns at times tᵢ₊₁, t₁₊₂, tᵢ₊₃, and tᵢ₊₄, respectively, so as to obtain the input images at time tᵢ₊₁, tᵢ₊₂, tᵢ₊₃, and tᵢ₊₄ Thus, it is possible to generate the image with improved resolution at time tᵢ₊₄ by the resolution improving process based on the displacement amounts among the input images at times tᵢ₊₁ to tᵢ₊₄.

In this case, the displacement amounts among the input images at times tᵢ₊₁ to tᵢ₊₄ are determined considering a difference of the sampling position among the first, second, third, and fourth adding patterns. As the resolution improving process based on the plurality of images obtained by using the plurality of different adding patterns, a known method (e.g., the super-resolution process method described in JP-A-2009-124621) can be used. Note that the noise reduction processing unit 55 should perform the noise reduction process after a process of canceling the above-mentioned difference of the sampling position. Alternatively, the noise reduction process should be performed considering the above-mentioned difference of the sampling position. In addition, in the example described above, the adding pattern to be used is changed one by one among the four types of adding patterns for performing the addition reading. However, the total number of the adding pattern to be used may be any number of two or larger.

### Example 9

Example 9 will be described. In the above description, it is supposed that when the output image is generated on the basis of the input image obtained by the skip reading, the weight coefficient k_{W} is set to one so that the noise reduction process does not contribute to the output image (see FIGS. 11A, 11B, 12A and 12B). In this case, it is possible that the noise reduction process contributes to the output image.

In order to realize this, although different from the above description of other examples, the threshold value TH1 is set to a value smaller than four in Example 9 (see FIGS. 11B and 12B). Ultimately, it is possible to set TH1 to one. When the threshold value TH1 is set to a value smaller than four, the weight coefficient k_{W} may be set to a value smaller than one also in the case where the output image is generated on the basis of the input image obtained by the skip reading. If the weight coefficient k_{W} is set to a value smaller than one, the image with improved resolution and noise reduced image become to contribute to the output image.

However, in the period where the skip reading is performed, the threshold value TH1 should be set (or the threshold values TH1 and TH2 should be set) so that the resolution improving process contributes relatively more largely to the output image than the noise reduction process does. In other words, in the period where the skip reading is performed, the weight coefficient k_{W} should be always set to a value larger than 0.5 so that the resolution improving process contributes relatively more largely to the output image than the noise reduction process does. In this case, in the period where the skip reading is performed, the weight coefficient k_{W} changes in accordance with G_{TOTAL} or B_{CONT} within the range where inequality 0.5<k_{W}≦1 is satisfied, so that the weight coefficient k_{W} becomes smaller as G_{TOTAL} or B_{CONT} becomes larger. However, it is possible to fix the weight coefficient k_{W} to be a constant value regardless of G_{TOTAL} or B_{CONT} within the range where the inequality 0.5<k_{W}≦1 is satisfied, in the period where the skip reading is performed.

Further, according to the weight coefficient setting method illustrated in FIGS. 11B and 12B, the weight coefficient k_{W} set in the execution period of the skip reading is always larger than the weight coefficient k_{W} set in the execution period of the addition reading. However, considering that the noise reduction effect can be obtained originally by the execution itself of the addition reading, the setting method of the weight coefficient k_{W} described above may be modified so that the weight coefficient k_{W} set in the execution period of the skip reading becomes smaller than the weight coefficient k_{W} set in the execution period of the addition reading (such modification can be useful particularly in the period before and after the timing when the drive system of the image sensor 33 is switched between the skip reading and the addition reading).

### Example 10

Example 10 will be described. While one moving image is being taken (in other words, during an image taking period of one moving image), the method of switching the drive system of the image sensor 33 between the addition reading method and the skip reading method on the basis of the sensitivity information or the brightness information is described in some of examples above. Image taking of one moving image (in other words, the image taking period of one moving image) starts when an imaging start instruction of the moving image is issued and ends when an imaging end instruction of the moving image is issued. For instance, a first pressing operation of the record button 26a (see FIG. 1) by the user can be assigned to the imaging start instruction of the moving image, and a second pressing operation of the record button 26a by the user can be assigned to the imaging end instruction of the moving image.

The method of switching the drive system of the image sensor 33 while one moving image is being taken (in other words, during the image taking period of one moving image) is not limited to the above-mentioned method. For instance, it is possible to switch the drive system of the image sensor 33 between the addition reading method and the skip reading method on the basis of the sensitivity information or the brightness information as described above in one of examples above, as a rule, while a moving image is being taken, and to set the drive system of the image sensor 33 to the skip reading method when the image taking instruction of a still image is issued while a moving image is being taken. Alternatively, for example, it is possible to set the drive system of the image sensor 33 to the addition reading method as a rule while a moving image is being taken, and to set the drive system of the image sensor 33 to the skip reading method when the image taking instruction of a still image is issued during the image taking period of a moving image.

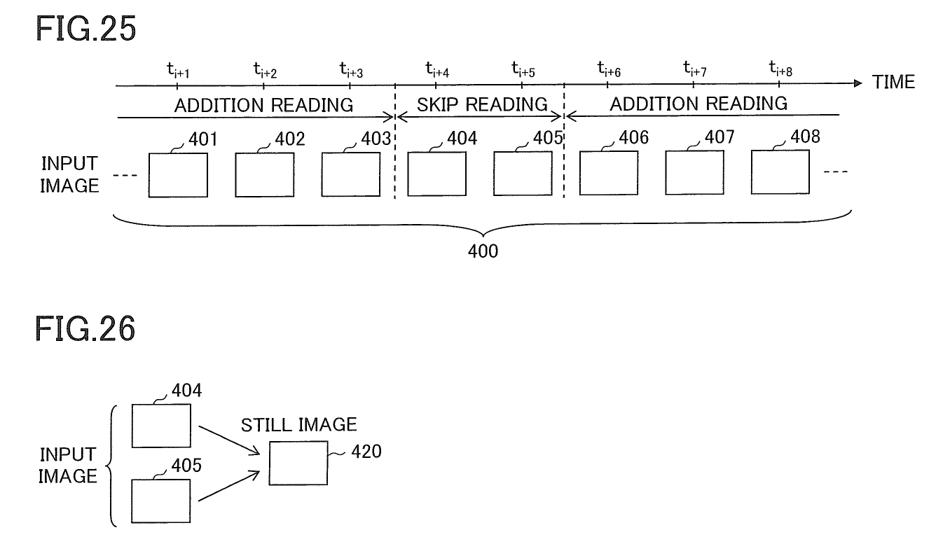

Here, it is supposed that the input images 401 to 408 illustrated in FIG. 25 are sequentially obtained, and the setting method of the drive system according to Example 10 will be described. The moving image 400 to be obtained in accordance with the imaging start instruction and the imaging end instruction of a moving image includes the input images 401 to 408 or a plurality of output images based on the input images 401 to 408 as frames. A plurality of times tᵢ₊₁ to tᵢ₊₈ are times in the image taking period of the moving image 400. The input images 401 to 408 correspond to input images at times tᵢ₊₁ to tᵢ₊₈, respectively (as described above, i denotes an integer).

In the example illustrated in FIG. 25, still image taking trigger is generated between time tᵢ₊₃ and time tᵢ₊₄. The still image taking trigger is generated in the image sensing apparatus 1 when the user issues the image taking instruction of a still image to the image sensing apparatus 1. The image taking instruction of a still image is realized, for example, when the user presses the shutter button 26b (see FIG. 1). When the still image taking trigger is generated between time tᵢ₊₃ and tᵢ₊₄, the main control unit 51 illustrated in FIG. 8 or the like sets a particular period for a still image after time tᵢ₊₃. This particular period is a period for taking two or more input images. During the image taking period of the moving image 400, in the period except the particular period, the drive system of the image sensor 33 is switched between the addition reading method and the skip reading method on the basis of the sensitivity information or the brightness information. Alternatively, during the image taking period of the moving image 400, in the period except the particular period, the drive system of the image sensor 33 may be fixed to the addition reading method. On the other hand, the input images taken in the particular period are obtained by the skip reading.

In the example illustrated in FIG. 25, time tᵢ₊₄ and tᵢ₊₅ are included in the particular period. As a result, the input images 404 and 405 as the input images in the particular period are obtained by the skip reading. On the other hand, the input images 401 to 403 and 406 to 408 which are input images outside the particular period are obtained by using the addition reading or the skip reading selectively on the basis of the sensitivity information or the brightness information. Alternatively, they are obtained by using the addition reading in a fixed manner. In the example illustrated in FIG. 25, the input images 401 to 403 and 406 to 408 are obtained by using the addition reading.

In accordance with the method described above with reference to FIG. 8 or the like, eight output image can be generated from the eight input images 401 to 408, and each of the generated eight output images can be handled as a frame of the moving image 400. When the output images to be frames of the moving image 400 are generated from the input images 401 to 408, the method described above in Examples 4 to 6 may be used so that the switching of the drive system becomes inconspicuous.

On the other hand, the image sensing apparatus 1 can generate one still image 420 from the input images 404 and 405 (see FIG. 26) by using the resolution improvement processing unit 54 (see FIG. 8 or the like).

For instance, the image with improved resolution based on the input images 404 and 405 may be generated as the still image 420. In other words, for example, the input images 404 and 405 may be combined on the basis of the displacement amount between the input images 404 and 405 so as to generate the image with improved resolution, and this image with improved resolution may be handled as the still image 420.

Alternatively, for example, the image with improved resolution based on the input images 404 and 405, and the noise reduced image based on the input images 404 and 405 may be generated, and the generated image with improved resolution and noise reduced image may be combined so that the obtained output image is handled as the still image 420. In this case, the above-mentioned weight coefficient k_{W} should be set so that the resolution improving process contributes relatively more largely to the output image (still image 420) than the noise reduction process does (i.e., 0.5<k_{W}<1 should be satisfied).

In addition, when the input images 404 and 405 are obtained by using the skip reading, the method described above in Example 8 may be used. In other words, the thinning patterns to be used for obtaining the input images 404 and 405 may be different from each other. In addition, the still image 420 may be used as a frame of the moving image 400.

Further, in the example illustrated in FIG. 25, the number of input images obtained by using the skip reading during the particular period is two, but the number may be three or larger. In this case, the still image corresponding to the still image 420 is generated from three or more input images obtained by using the skip reading during the particular period.

In the case where the drive system before the image taking instruction of a still image is the addition reading method, noise of the input image increases when the drive system is switched to the skip reading method, but as illustrated in FIG. 25, the input image in the particular period is obtained by the skip reading so that the still image with high resolution can be obtained.

<<Variations>>

The specific numerical values indicated in the above description are merely examples, and as a matter of course, the values can be changed to various numerical values. As variation examples or annotations of the embodiments described above, Notes 1 to 6 are described below. Descriptions in individual Notes can be combined arbitrarily as long as no contradiction arises.

[Note 1]

The amplification factor Ga is an amplification factor when the pixel signal is amplified in the signal processing stage. In the description above, for simple description, it is supposed that amplification of the pixel signal in the signal processing stage is performed only by the AFE 12, and it is considered that the amplification factor Ga is an amplification factor itself of the AFE 12. However, if the amplification of the pixel signal is performed also in the post-stage of the AFE 12 (i.e., in the video signal processing unit 13), an amplification factor in which the amplification is taken account becomes the amplification factor Ga. In other words, if the amplification of the pixel signal is performed also in the post-stage of the AFE 12 (i.e., in the video signal processing unit 13), a product of the amplification factor of the AFE 12 and the amplification factor in the post-stage of the AFE 12 (i.e., in the video signal processing unit 13) should be regarded as the amplification factor Ga.

[Note 2]

The specific methods of thinning the light receiving pixels described above are merely examples, which can be modified variously. For instance, the thinning is performed in the above-mentioned skip reading so that four light receiving pixel signals are read out from 4×4 light receiving pixels, but it is possible to perform the thinning so that four light receiving pixel signals are read out from 6×6 light receiving pixels.

The specific methods of adding the light receiving pixel signals described above are merely examples, which can be modified variously. For instance, the above-mentioned addition reading adds four light receiving pixels signals so as to generate the pixel signal of one pixel on the original image, but it is possible to add other number of light receiving pixel signals (e.g., nine or sixteen light receiving pixel signals) so as to generate the pixel signal of one pixel on the original image. The above-mentioned amplification factor Go in the addition reading can change in accordance with the number of light receiving pixel signals to be added.

[Note 3]

The embodiment described above embodies simultaneously the invention in which the skip reading and the addition reading are switched and performed in accordance with the main control information, and the invention in which the weight coefficient k_{W} when the image with improved resolution and the noise reduced image are combined is determined in accordance with main control information. However, it is possible to embody only the former invention or to embody only the latter invention.

[Note 4]

It is supposed in the embodiment described above that the single plate method using only one image sensor is adopted for the image sensor 33, but a three-plate method using three image sensors may be applied to the image sensor 33. When the three-plate method is used, the above-mentioned demosaicing process becomes unnecessary.

[Note 5]

The image sensing apparatus 1 illustrated in FIG. 1 may be constituted of hardware, or a combination of hardware and software. When software is used for constituting the image sensing apparatus 1, a block diagram of a part realized by software indicates a functional block diagram of the part. The function realized by using software may be described as a program, and the program may be executed on a program executing apparatus (e.g., a computer) so as to realize the function.

[Note 6]

For instance, it is possible to consider as follows. The main control unit 51 illustrated in FIG. 8 or the like has a function as a read control unit for controlling the drive system of the image sensor 33 (signal reading method). Further, the main control unit 51 also has a function of controlling a contribution degrees of the resolution improving process and the noise reduction process to the output image by setting the weight coefficient k_{W}. The image sensing apparatus 1 is provided with the image processing unit which generates the output image from the input image by using the resolution improving process and the noise reduction process. The image processing unit includes at least the resolution improvement processing unit 54, the noise reduction processing unit 55, and the weighted addition unit 56. In addition, the image processing unit may include a part or a whole of the displacement detection unit 53, the frame interpolation unit 57, and the edge decision unit 58. It is also possible to consider that the main control unit 51 is also included in the image processing unit as its element.

What is claimed is:

1. An image sensing apparatus for taking an image, comprising:
an image sensor constituted of a light receiving pixel group which performs photoelectric conversion of an optical image of a subject; and
a read control unit which performs switching between skip reading for thinning a part of the light receiving pixel group while reading an output signal of the light receiving pixel group, and addition reading for adding output signals of a plurality of light receiving pixels included in the light receiving pixel group while reading the same, wherein
the read control unit performs the switching between the skip reading and the addition reading while one moving image is being taken.

2. An image sensing apparatus according to claim 1, wherein the read control unit performs the switching between the skip reading and the addition reading on the basis of information corresponding to imaging sensitivity.

3. An image sensing apparatus according to claim 2, wherein the read control unit performs the switching so that the skip reading is performed when the sensitivity is relatively low while the addition reading is performed when the sensitivity is relatively high.

4. An image sensing apparatus according to claim 3, wherein in a process of changing from a state where the sensitivity is relatively low to a state where the sensitivity is relatively high, the read control unit sets a period where only the skip reading is performed continuously, a period where only the addition reading is performed continuously, and a period disposed between them where the skip reading and the addition reading are performed in a mixed manner.

5. An image sensing apparatus according to claim 3, wherein in a process of changing from a state where the sensitivity is relatively high to a state where the sensitivity is relatively low, the read control unit sets a period where only the addition reading is performed continuously, a period where only the skip reading is performed continuously, and a period disposed between them where the skip reading and the addition reading are performed in a mixed manner.

6. An image sensing apparatus according to claim 1, wherein the read control unit performs the switching between the skip reading and the addition reading on the basis of information corresponding to brightness of the subject.

7. An image sensing apparatus according to claim 6, wherein the read control unit performs the switching so that the skip reading is performed when the brightness is relatively high, and the addition reading is performed when the brightness is relatively low.

8. An image sensing apparatus according to claim 7, wherein in a process of changing from a state where the brightness is relatively high to a state where the brightness is relatively low, the read control unit sets a period where only the skip reading is performed continuously, a period where only the addition reading is performed continuously, and a period disposed between them where the skip reading and the addition reading are performed in a mixed manner.

9. An image sensing apparatus according to claim 7, wherein in a process of changing from a state where the brightness is relatively low to a state where the brightness is relatively high, the read control unit sets a period where only the addition reading is performed continuously, a period where only the skip reading is performed continuously, and a period disposed between them where the skip reading and the addition reading are performed in a mixed manner.

10. An image sensing apparatus according to claim 2, further comprising an image processing unit which generates an output image from a taken image obtained from the image sensor by using first image processing for improving resolution of the taken image and second image processing for reducing noise of the taken image, wherein the image processing unit generates the output image, in the case where the taken image is obtained by the addition reading, so that the first image processing contributes to the output image more than the second image processing does when the sensitivity is relatively low, and that the second image processing contributes to the output image more than the first image processing does when the sensitivity is relatively high.

11. An image sensing apparatus according to claim 6, further comprising an image processing unit which generates an output image from a taken image by using first image processing for improving resolution of the taken image obtained from the image sensor and second image processing for reducing noise of the taken image, wherein the image processing unit generates the output image, in the case where the taken image is obtained by the addition reading, so that the first image processing contributes to the output image more than the second image processing does when the brightness is relatively high, and that the second image processing contributes to the output image more than the first image processing does when the brightness is relatively low.

12. An image sensing apparatus according to claim 10, wherein when the taken image is obtained by the skip reading, the image processing unit generates the output image by the first image processing without the second image processing contributing to the output image, or generates the output image so that the first image processing contributes to the output image more than the second image processing does.

13. An image sensing apparatus according to claim 11, wherein when the taken image is obtained by the skip reading, the image processing unit generates the output image by the first image processing without the second image processing contributing to the output image, or generates the output image so that the first image processing contributes to the output image more than the second image processing does.

14. An image sensing apparatus according to claim 1, wherein if an instruction to take a still image is issued while the moving image is being taken, the read control unit performs the switching so that the still image is taken by using the skip reading.

15. An image sensing apparatus according to claim 1, wherein when the skip reading is performed, the read control unit uses a plurality of thinning patterns having different light receiving pixels to be thinned for obtaining a plurality of taken images.

16. An image sensing apparatus according to claim 1, wherein when the addition reading is performed, the read control unit uses a plurality of adding pattern having different combinations of the light receiving pixels to be added up for obtaining a plurality of taken images.

17. An image sensing apparatus comprising an image processing unit which generates an output image from a taken image obtained from an image sensor by using first image processing for improving resolution of the taken image and second image processing for reducing noise of the taken image, wherein the image processing unit performs:
generation of the output image so that the first image processing contributes to the output image more than the second image processing does when imaging sensitivity is relatively low, and that the second image processing contributes to the output image more than the first image processing does when the sensitivity is relatively high; or
generation of the output image so that the first image processing contributes to the output image more than the second image processing does when brightness of a subject is relatively high, and that the second image processing contributes to the output image more than the first image processing does when the brightness is relatively low.
